(19) United States
(12) Patent Application Publication
(10) Pub. No.: US 2026/0067846 A1
(43) Pub. Date: Mar. 5, 2026

(54) WIRELESS COMMUNICATION DEVICE TRANSMIT AND RECEIVE PATTERNS FOR ENERGY-EFFICIENT POSITIONING

(71) Applicant: QUALCOMM Incorporated, San Diego, CA (US)

(72) Inventors: Varun Amar REDDY, San Diego, CA (US); Zhifei FAN, San Diego, CA (US); Chengjin ZHANG, San Diego, CA (US)

(21) Appl. No.: 18/823,563

(22) Filed: Sep. 3, 2024

(51) Int. Cl. H04W 64/00; H04B 17/318; H04W 56/00

(52) U.S. Cl. CPC H04W 64/00; H04B 17/318; H04W 56/0015

(57) ABSTRACT

Systems and techniques are described herein for wireless communications. For example, a network entity can determine a group of wireless communication device radios of a plurality of wireless communication device radios for positioning a target device. The network entity can determine, based on criteria, a communications pattern for the group of wireless communication device radios. The network entity can transmit, to the group of wireless communication device radios, an indication of the communications pattern to use for communications with the target device for positioning the target device.

### FIELD

The present disclosure generally relates to wireless communications. For example, aspects of the present disclosure relate to wireless communication device (e.g., electronic shelf label (ESL) or other wireless communication device) transmit (Tx) and receive (Rx) patterns for energy-efficient positioning.

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for providing transmit (Tx) and receive (Rx) patterns for energy-efficient positioning for wireless communication devices. In some aspects, a network entity for wireless communications is provided. The network entity can include at least one memory and at least one processor coupled to the at least one memory and configured to: determine a group of wireless communication device radios of a plurality of wireless communication device radios for positioning a target device; determine, based on criteria, a communications pattern for the group of wireless communication device radios; and output, for transmission to the group of wireless communication device radios, an indication of the communications pattern to use for communications with the target device for positioning the target device.

In some aspects, a method for wireless communications at a network entity is provided. The method includes: determining a group of wireless communication device radios of a plurality of wireless communication device radios for positioning a target device; determining, based on criteria, a communications pattern for the group of wireless communication device radios; and transmitting, to the group of wireless communication device radios, an indication of the communications pattern to use for communications with the target device for positioning the target device.

In some aspects, a non-transitory computer-readable medium of a computing device is provided having stored thereon instructions that, when executed by at least one processor, cause the at least one processor to: determine a group of wireless communication device radios of a plurality of wireless communication device radios for positioning a target device; determine, based on criteria, a communications pattern for the group of wireless communication device radios; and output, for transmission to the group of wireless communication device radios, an indication of the communications pattern to use for communications with the target device for positioning the target device.

In some aspects, an apparatus is provided for wireless communications. The apparatus includes: means for determining a group of wireless communication device radios of a plurality of wireless communication device radios for positioning a target device; means for determining, based on criteria, a communications pattern for the group of wireless communication device radios; and means for transmitting, to the group of wireless communication device radios, an indication of the communications pattern to use for communications with the target device for positioning the target device

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a diagram illustrating an example of a system, in accordance with aspects of the present disclosure.

FIG. 4 is a diagram illustrating an example of a system, where objects are being stocked in a warehouse environment, in accordance with aspects of the present disclosure.

FIG. 5 is a diagram illustrating an example of a wireless communication devices equipped with radios, in accordance with aspects of the present disclosure.

FIG. 6 is a diagram illustrating an example of a wireless communication device rail, in accordance with aspects of the present disclosure.

FIG. 7 is a diagram illustrating an example of a convex region formed by wireless communication devices equipped with radios, in accordance with aspects of the present disclosure.

FIG. 8 is a signaling diagram illustrating example communication transmissions, in accordance with some aspects of the present disclosure.

FIG. 9 is a signaling diagram illustrating an example of communication transmissions between a network device and two groups of wireless communication devices, in accordance with some aspects of the present disclosure.

FIG. 10 is a signaling diagram illustrating examples of communication transmissions, in accordance with some aspects of the present disclosure.

FIG. 11 is a diagram illustrating an example of a radio frequency (RF) energy harvesting device, in accordance with some aspects of the disclosure.

FIG. 12 is a flow diagram illustrating an example of a process for wireless communications, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Short range wireless communication protocols enable wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHZ.

BLUETOOTH® Low Energy (BLE) is a form of BLUETOOTH® communication that allows for communication with devices that operate using low power. Such devices may include wireless communication devices that can use low-energy communication technology for positioning, proximity marketing, or other purposes.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME) or edge server, via at least one network device, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME (e.g., edge server), each peripheral device (e.g., ESL) may have a wireless connection (e.g., a BLE connection or other connection) to an AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

Each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

In some cases, an ESL may lose synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. PAwR allows BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices. When the ESLs are powered, the ESLs can scan to receive a wake up packet (WUP) from the access point. The WUP can contain advertisement parameters for the ESLs. Upon receiving the WUP from the access point, the ESLs can transmit advertisement messages (e.g., a connectable advertisement (CAP)) on a legacy channel based on parameters (e.g., interval and duration parameters) received within the WUP. The access point can scan to receive the CAPs from the ESLs, and then create a generic attribute profile (GATT) connection with one of the advertising ESLs to perform onboarding of that ESL. The onboarding process involves the transfer of periodic advertisement synchronization transfer (PAST) information, where an access point can share its PAwR timing with the ESL. When multiple access points receive a CAP from an ESL, the access points can report the received CAP to the management entity. The management entity can then shortlist one of the access points to onboard the ESL.

A system (e.g., a system for asset tracking, monitoring, and/or supply chain management purposes, such as in a retail store or warehouse environment) may include one or more wireless communication devices that are controlled by a network entity. For example, a system may include one or more peripheral devices (e.g., wireless communication devices, such as in the form of ESLs) that are controlled by a network entity (e.g., an edge server) via at least one network device (e.g., an access point). In one or more examples, to facilitate control by the network entity (e.g., the edge server), each peripheral device (e.g., ESL) may have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the edge server) may be wirelessly transmitted to the peripheral devices (e.g., ESLs) by the network device (e.g., the access point). Responses or information from the peripheral devices may also be received by the network device, and provided by the network device to the network entity (e.g., by the access point to the edge server).

The peripheral devices in the system may include a plurality of ambient internet of things (IOT) devices (as examples of wireless communication devices or peripheral devices), which may each be in the form of a low cost, batteryless, energy harvesting tag, such as an electronic tag (eTag). One or more of the ambient IOT devices (e.g., tags) can each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), can interrogate, scan, read, probe, and/or energize the ambient IOT devices. Such energizing devices can be in the form of mobile devices (e.g., smart phones, tablet computers, handheld reader devices, etc.), robots, forklifts, or other devices.

The ambient IOT devices (e.g., being batteryless) may be powered by harvesting energy (e.g., power) from signals (e.g., energizing signals, RF signals, sweeping beams, or energizing waveforms) transmitted from the devices (such as energizing devices). After being energized, the ambient IOT devices can each transmit a response signal (e.g., a beacon) including some identifying information (e.g., metadata) that is unique to each ambient IOT device. Near field communication (NFC) tags can support communication as well. An edge server may store and maintain a database of information pertaining to the ambient IOT devices (e.g., information related to their capabilities and last known locations).

In certain scenarios, for a system (e.g., a system for asset tracking, monitoring, and/or supply chain management purposes, such as in a retail store or warehouse environment), for estimating a device's position, the device may only be able to obtain received signal strength indicator (RSSI) measurements. The device may be a low-cost device (e.g., an ambient IOT device, such as in the form of an etag), which may not be able to obtain time of arrival (ToA) or angle of arrival (AoA) measurements, which require the device to have advanced processing capabilities.

In some cases, an anchor node infrastructure may be employed by the system for positioning. In an anchor node infrastructure, one or more anchor nodes may be used for positioning of one or more target devices. The one or more anchor nodes are each located in a known respective position. In some cases, wireless communication devices (e.g., ESLs) may be used as anchor devices. The one or more target devices are each located in an unknown respective position. In one or more cases, the one or more target devices may be one or more ambient IOT devices (e.g., etags) and/or one or more mobile devices (e.g., such as a mobile phone or smartphone associated with a user). The anchor node infrastructure, however, may not support timing measurements (e.g., such as ESL and legacy versions of W-Fi access points that do not support two-way ranging using ToA measurements).

Although being a low-complexity approach, RSSI-based positioning typically yields lower accuracies, which are proportional to the density of the anchor nodes. As such, in large stores and warehouses, where access points tend to be located far apart (e.g., twenty-five to thirty meters) from each other, the positioning accuracy tends to be low. This effect can be exacerbated in macro-scenarios, where base stations (e.g., which may be in the form of gNodeBs (gNBs)) are used as anchor nodes and are located several hundreds of meters apart from each other.

As such, improved systems and techniques for accurate energy-efficient positioning for target devices can be beneficial.

In one or more aspects of the present disclosure, systems, apparatuses, methods (also referred to as processes), and computer-readable media (collectively referred to herein as “systems and techniques”) are described herein that provide solutions for wireless communication device (e.g., ESL) transmit and receive patterns for energy-efficient positioning.

Various aspects relate generally to wireless communications. Some aspects more specifically relate to systems and techniques that provide solutions that use a wireless communication device (e.g., ESL) infrastructure. A wireless communication device (e.g., ESL) infrastructure can provide a highly-dense network of anchor nodes that can achieve sub-meter positioning accuracy in retail store (or warehouse) settings, albeit with constraints on power consumption, when the ESLs are battery-powered. The system and techniques focus on the wireless communication device (e.g., ESL) radio power conservation issue, where the systems and techniques optimize a trade-off between accuracy and power consumption in the form of transmit and/or receive patterns that are imposed on the wireless communication device (e.g., ESL) radio operations. In one or more examples, the wireless communication device (e.g., ESL) transmit and receive patterns for positioning (e.g., including both device-based and network-based approaches) utilize spatial and temporal interleaving. In some examples, the certain criteria may be used for selecting and switching between transmit/receive patterns. In one or more examples, the systems and techniques can tackle asymmetry between position estimation of mobile devices, such as mobile phones (e.g., utilizing downlink (DL)-RSSIs), and position estimation of ambient IOT devices, such as etags (e.g., utilizing uplink (UL)-RSSIs).

In one or more examples, one or more clusters of wireless communication devices (e.g., ESLs) may be chosen, based on their locations and a coarse location (e.g., an area) of a target device (e.g., ambient IOT device or mobile device). Each wireless communication device cluster (e.g., ESL cluster) may be configured to transmit and/or receive over fixed slots based on a duty cycle. This transmit/receive configuration may be made available to the target device. The sizes of wireless communication device (e.g., ESL) clusters and their duty cycles may be adjusted accordingly, based on wireless communication device power and positioning accuracy requirements. In some examples, when wireless communication device (e.g., ESL) radios need to perform both transmitting and receiving, power may be conserved by using different cluster and duty cycle patterns for receiving and/or transmitting of signals.

In one or more aspects, during operation for wireless communications at a network entity, the network entity can determine a group of wireless communication device (e.g., ESL) radios of a plurality of wireless communication device radios for positioning a target device. The network entity can determine, based on criteria, a communications pattern for the group of wireless communication device radios. The network entity can transmit, to the group of wireless communication device radios, an indication of the communications pattern to use for communications with the target device for positioning the target device.

In one or more examples, determining the group of wireless communication device radios of the plurality of wireless communication device radios can be based on a known area comprising the target device. In some examples, the criteria can include confidence in a location estimate of the target device, a time of day, foot traffic for an area comprising the target device, an accuracy requirement associated with a use case for the target device, a buffer capacity for each wireless communication device radio of the plurality of wireless communication device radios, presence of an uplink interference, and/or a use case associated with an identifier of the target device.

In one or more examples, the target device can be an ambient IOT device or a mobile device. In some examples, when the target device is an ambient IOT device, the communications pattern can be a receive pattern for the group of wireless communication device radios to receive from the target device. In one or more examples, the ambient IOT device can be an energy harvesting electronic tag (etag).

In some examples, when the target device is a mobile device, the communications pattern can be a transmit pattern for the group of wireless communication device radios to transmit to the target device. In one or more examples, the network entity can group wireless communication device radios within the group of wireless communication device radios into a plurality of clusters. In some examples, the wireless communication device radios within each cluster of the plurality of clusters can have a uniform spatial geometry. In one or more examples, the communications pattern can include staggered transmissions across time for the wireless communication device radios within each cluster of the plurality of clusters. In one or more examples, the communications pattern can include staggered transmissions across time for wireless communication device radios across different clusters of the plurality of clusters. In some examples, the mobile device can be smartphone, a smart watch, or a tablet. In one or more examples, the network entity can be a management entity (e.g., edge server). In some examples, each wireless communication device radio of the plurality of wireless communication device radios can be an electronic shelf label (ESL) radio.

Particular aspects of the subject matter described in this disclosure can be implemented to realize one or more of the following potential advantages. In one or more examples, the systems and techniques can provide a benefit of reducing power consumption for batteries associated with ESL radios. In some examples, the systems and techniques can provide a benefit of providing accurate positioning of target devices, including ambient IOT devices (e.g., etags) and/or mobile devices (e.g., mobile phones, such as smartphones).

Additional aspects of the present disclosure are described in more detail below.

As used herein, the term “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

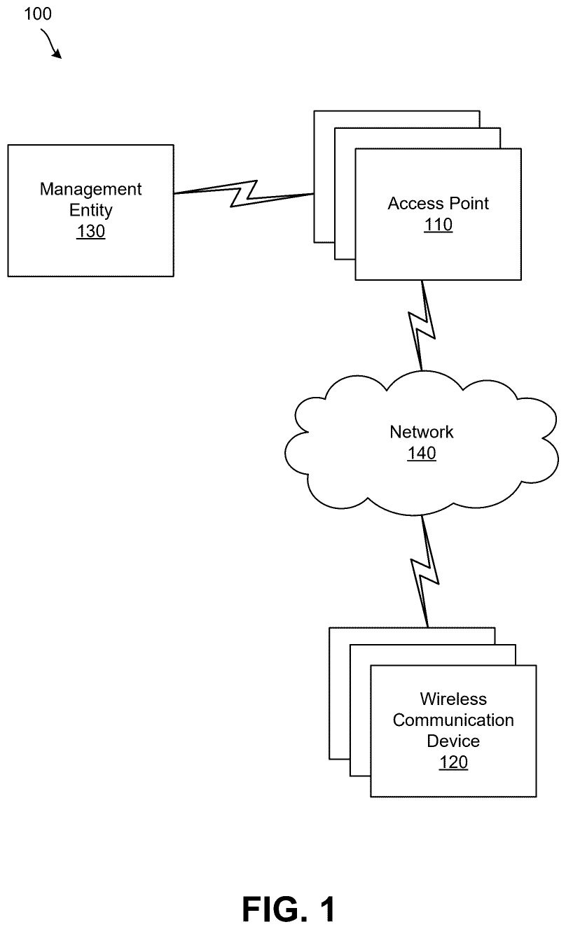

According to various aspects, FIG. 1 is a diagram of an example environment 100 in which systems and/or methods described herein may be implemented. As shown in FIG. 1, the environment 100 may include at least one access point (AP) 110 (e.g., a network device), at least one wireless communication device 120 (e.g., at least one ESL), a management entity (ME) 130 (e.g., a network entity), and a network 140. Devices of the environment 100 May interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

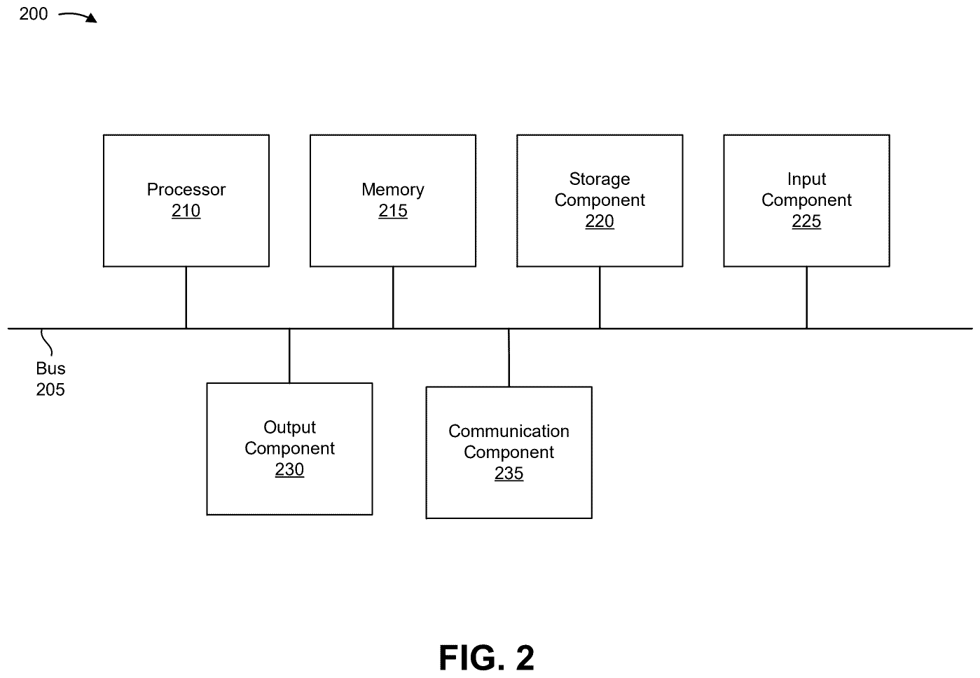

FIG. 2 is a diagram illustrating example components of a device 200, in accordance with the present disclosure. Device 200 may correspond to access point 110, wireless communication device 120 (e.g., an ESL), and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

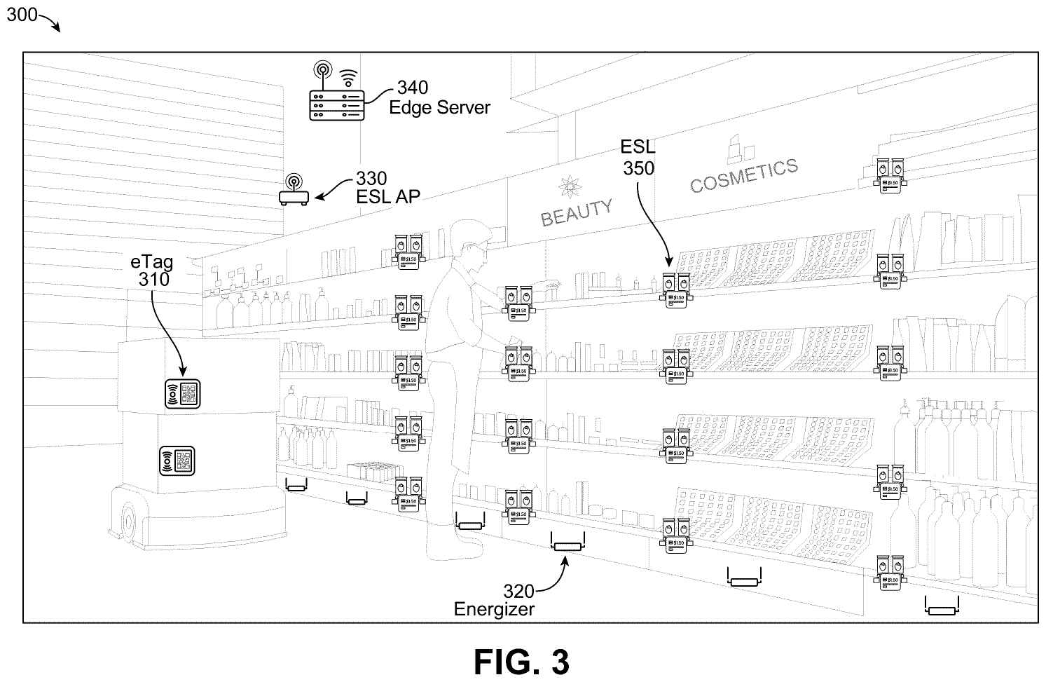

As previously mentioned, a system (e.g., a system for asset tracking, monitoring, and/or supply chain management purposes, such as in a retail store or warehouse environment) can include one or more wireless communication devices that are controlled by a network entity. For example, a system may include one or more peripheral devices (e.g., wireless communication devices, such as wireless communication devices 120 of FIG. 1, for example in the form of ESLs) that are controlled by a network entity (e.g., an edge server, such as network entity 340 of FIG. 3) via at least one network device (e.g., an access point, such as access point 110 of FIG. 1). In one or more examples, to facilitate control by the network entity (e.g., the edge server), each peripheral device (e.g., ESL) can have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the edge server) can be wirelessly transmitted to the peripheral devices (e.g., ESLs) by the network device (e.g., the access point). Responses or information from the peripheral devices can also be received by the network device, and provided by the network device to the network entity (e.g., by the access point to the edge server).

The peripheral devices in the system can include a plurality of ambient IOT devices (as examples of wireless communication devices or peripheral devices), which may each be in the form of a low cost, batteryless, energy harvesting tag (e.g., ambient IOT devices 310 of FIG. 3). One or more of the ambient IOT devices (e.g., ambient IOT tags) may each be attached to an asset located within a location or environment (e.g., a retail store, a warehouse, etc.) for asset tracking, monitoring, and/or supply chain management purposes. Devices, such as devices for energizing (e.g., which may be referred to as “energizing devices”, “energizers”, or “readers”, such as energizing devices 320 of FIG. 3), may interrogate, scan, read, probe, and/or energize the ambient IOT devices. Such devices may be in the form of mobile devices (e.g., smart phones, tablet computers, handheld reader devices, etc.), robots, forklifts, or other devices.

The ambient IOT devices, being batteryless, can be powered by harvesting energy (e.g., power) from signals (e.g., energizing signals, RF signals, sweeping beams, or energizing waveforms) transmitted from the devices (e.g., the energizing devices). After being energized, the ambient IOT devices may each transmit a response signal including some identifying information (e.g., metadata) that is unique to each ambient IOT device. NFC tags may support communication as well. The edge server can store and maintain a database of information pertaining to the ambient IOT devices (e.g., information related to their capabilities and last known locations).

In one or more aspects, the system (e.g., including energizing devices) can be utilized to trigger ambient IOT devices to send response signals including their respective identifying information. In one or more examples, ambient IOT devices of a system (e.g., deployed within a retail store) may be configured to transmit beacon frames (e.g., response signals, which may include identifying information associated with the ambient IOT devices).

FIG. 3 shows an example of system (e.g., deployed within a retail store). In particular, FIG. 3 is a diagram illustrating an example of a system 300. In FIG. 3, the system 300 is shown to be located within a retail store. The system 300 employs wireless communication device (e.g., ESL) radios as anchor nodes for positioning of target devices, which may be in the form of ambient IOT devices 310 (e.g., etags) and/or mobile devices (e.g., mobile phones).

The system 300 of FIG. 3 is shown to include a network entity 340 (e.g., in the form of an edge server or gateway node or management entity, which may be located within the retail store), a network device 330 (e.g., an access point, which may be located within the retail store), ambient IOT devices 310 (e.g., energy harvesting BLE tags, for example eTags, that are each associated with a parcel), energizing devices 320 (e.g., energizers mounted on the shelving units within the retail store), and wireless communication devices 350 (e.g., in the form of ESLs that are mounted on the shelving units, where the ESLs are powered and controlled by an electric rail mounted within the shelving units, and the ESLs are associated with ESL radios).

In one or more aspects, the energizing devices 320 (e.g., energizers mounted on a shelf, mobile devices, such as a smart phone, a robot, a fork lift, etc.) may have one or more capabilities. In one or more examples, the energizing devices 320 may have a capability of supporting RFID technology, which may include the ability to read and scan an ambient IOT device 310 (e.g., in the form of an RFID tag, such as an eTag), and include the ability to support communications using one or more frequency bands related to RFID technology, such as low frequency (LF), high frequency (HF), near field communication (NFC) frequency, and ultra-high frequency (UHF). In some examples, the energizing devices 310 may have an energizing capability, which can include the ability to energize an ambient IOT device 310 and to instruct the ambient IOT device 310 to communicate (e.g., via a broadcast or a unicast) with another device (e.g., communicate information about a particular item to an access point, such as for inventory purposes). In one or more examples, the energizing devices 320 may have a capability to support beamforming (e.g., a beamforming capability to be able to form an antenna beam and scan, for example steer, the beam towards a particular ambient IOT device 310), such as for the purpose of interrogating the ambient IOT device 310.

In one or more examples, the energizing devices 320 may have a capability to support radio communications, such as radio frequency (RF) communications (e.g., using cellular, satellite, Wi-Fi, and/or Bluetooth communications). For example, the energizing devices 320 may be able to receive transmissions (e.g., RF signal transmissions) from one or more ambient IOT devices 310 (e.g., each in the form of a tag, such as an eTag), such as for the purpose of relaying the received information to a network device 330 (e.g., access point) and a network entity 340 (e.g., an edge server).

In some examples, the energizing devices 320 may have a capability of including a camera for capturing images and/or video of the surrounding environment (e.g., within the retail store or warehouse). The energizing devices 320 may receive information (e.g., about a product associated with an ambient IOT device 310) via images taken by the camera of the local environment.

In one or more examples, the energizing devices 320 may have a capability of having transparency, which may include an ability to share information associated with one or more ambient IOT devices 310, which may each be in the form of a tag (e.g., an eTag), with a network entity 340, such as an edge server. In some examples, the energizing devices 320 may have the capability to share information (e.g., prices, expiration dates, and/or online reviews related to the items associated with the ambient IOT devices 310) to a user or a store employee by displaying the information on a graphical user interface (GUI), which may be implemented within the energizing devices 320. In one or more examples, when an energizing device 320 is able to share information associated with one or more ambient IOT devices 310, there may be an expected latency (e.g., an expected amount of delay in time) in the energizing device 320 delivering the information to the network entity 340, such as an edge server.

In one or more aspects, ambient IOT devices 310, which may each be in the form of a tag (e.g., an eTag), may have one or more capabilities. In one or more examples, the ambient IOT devices 310 may be part of a larger system, such as a system that includes wireless communication devices 350 (e.g., ESLs) and/or rail controllers, which may each be equipped with wireless radios (e.g., RF radios, such as ESL radios) and/or cameras.

In one or more examples, the ambient IOT devices 310 may have one or more of the same capabilities as previously mentioned for the energizing devices 320, except for the energizing and beamforming capabilities. For example, the ambient IOT devices 310 may have capabilities including the ability to support RFID technology (e.g., which can include the ability to harvest energy from received signals (energizer signals or transmissions) from energizing devices 320 and to transmit identifying information after being sufficiently energized with power), the ability to operate as a radio (e.g., the ability to receive transmissions from energizing devices 320 and to transmit signals to the energizing devices 320 and/or to the wireless communication devices 350), the ability to operate as a camera, and/or the ability to operate with transparency (e.g., by sharing identifying information for itself with energizing devices 320).

In one or more aspects, during operation of the system 300 of FIG. 3 within a retail store scenario, the energizing devices 320 can send (e.g., transmit) energizer signals (e.g., energizer transmissions) to the ambient IOT devices 310. The ambient IOT devices 310 can receive the energizer signals and harvest energy from the energizer signals to energize themselves. After the ambient IOT devices 310 have harvested enough energy to be able to transmit, the ambient IOT devices 310 (e.g., eTags) can send (e.g., transmit) beacons (e.g., beacon frames).

In one or more examples, the wireless communication devices 350 (e.g., ESL radios associated with ESLs with known positions and can operate as anchoring nodes), which are located within the vicinity of the ambient IOT devices 310 (e.g., etags with unknown positions and may be target devices), can receive the beacons transmitted from the ambient IOT devices 310 (e.g., eTags). In some examples, receivers (e.g., associated with the ESL radios) may receive the beacons, may obtain information from the beacons (e.g., information related to the ambient IOT devices 310 themselves, such as unique identifying information, and/or information related to items or product associated with the ambient IOT devices 310), and may obtain measurements (e.g., signal strength measurements, such as RSSIs) of the received beacons. In response to receiving the beacons, the receivers may not perform an interrogation itself, but rather may relay the information within and/or associated with (e.g., measurements, such as the RSSIs) the beacons to the network entity 340 (e.g., an edge server) via the network device 330 (e.g., access point).

In some aspects, the system 300 of FIG. 3 may include a mobile device (e.g., a mobile phone, such as a smartphone) that is associated with a user, who may be walking down an aisle of the store. In one or more examples, during operation of the system 300 within a retail store scenario, the wireless communication devices 350 (e.g., ESL radios, which are associated with ESLs, with known positions and can operate as anchoring nodes), which are located within the vicinity of the mobile device (e.g., with an unknown position and may be a target device), can send (e.g., transmit) beacons (e.g., beacon frames). The mobile device can then receive the beacons from the wireless communication devices 350 (e.g., ESL radios). The mobile device can may obtain information from the received beacons (e.g., information related to the wireless communication devices 350 themselves, such as unique identifying information) and/or may obtain measurements (e.g., signal strength measurements, such as RSSIs) of the received beacons. In one or more examples, the mobile device may utilizing the information and/or the measurements to determine a position of the mobile device.

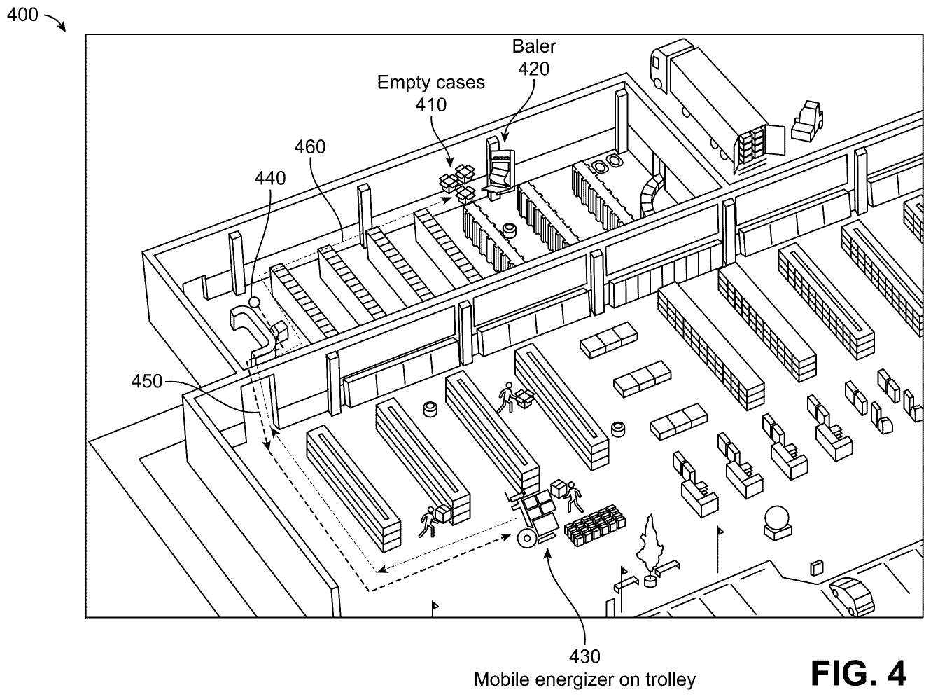

FIG. 4 shows an example of the use case (e.g., within a warehouse) for wireless communication device (e.g., ESL) assisted positioning. In particular, FIG. 4 is a diagram illustrating an example of a system 400, where objects (e.g., products) are being stocked in a warehouse environment. In FIG. 4, objects (e.g., products) within cases (e.g., boxes) are organized and stored at location 440 within a back room of the warehouse. In one or more examples, each of the cases (e.g., boxes) has an associated ambient IOT device (e.g., an etag). The movement of the cases (e.g., boxes) throughout the warehouse can be monitored via the ambient IOT devices (e.g., etags) associated with the cases (e.g., boxes), for example as described for the operation of the system 300, which utilizes wireless communication device (e.g., ESLs) radios as anchor nodes.

Throughout the day, selected cases (e.g., boxes) may be relocated (e.g., via traveling along path 450) to a front room of the warehouse. A trolley 430 (e.g., with an associated energizing device) may be used by a user (e.g., an employee) to relocate (e.g., move) the cases (e.g., boxes). When the cases (e.g., boxes) are located in the front room of the warehouse, a user (e.g., an employee) may open the cases and remove objects (e.g., products) from the cases. The user may then restock shelves (e.g., which may include wireless communication devices, such as in the form of ESLs) of shelving units with the objects (e.g., products). In one or more examples, the restocking may be performed during a certain period of the day, such as from ten (10) post meridiem (P.M.) to twelve (12) ante meridiem (A.M.). A tracking mechanism (e.g., positioning using wireless communication device (e.g., ESL) radios, as described for the system 300 of FIG. 3) is essential to monitor the final location of each case (e.g., box) after its contents (e.g., objects) have been arranged on the shelves of the shelving units.

After the objects have been removed from the cases (e.g., boxes), the empty cases 410 may be relocated (e.g., via traveling along path 460) from the front room of the warehouse to the back room of the warehouse. The trolley 430 (e.g., with an associated energizing device) may be used by a user (e.g., an employee) to relocate (e.g., move) the empty cases 410 to the back room. Once the empty cases 410 have been moved to the back room, a baler 420 located in the back room can be used to compress the empty cases 410 into a bale or a bundle.

In one or more examples, other use cases for wireless communication device (e.g., ESL) assisted positioning may include storewide tracking and anti-theft services for valuable objects.

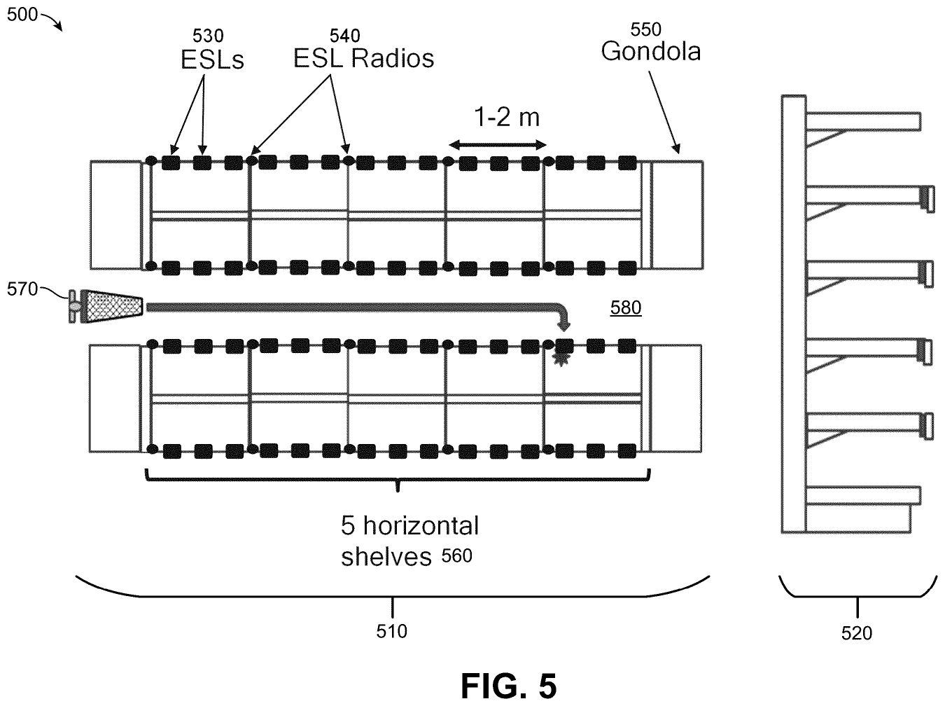

FIG. 5 shows an example configuration of wireless communication devices (e.g., the wireless communication devices 350) installed on shelves. In particular, FIG. 5 is a diagram illustrating an example 500 of a wireless communication devices (e.g., ESLs) equipped with radios (e.g., ESL radios) installed on shelves. In FIG. 5, two views of a retail store are shown. The two views include a top view 510 of the store (e.g., including two gondolas 550 in the form of shelving units) and a side view 520 of the store (e.g., including a side view of one of the gondolas 550). In the top view 510, each of the gondolas 550 (e.g., shelving units) includes a plurality of (e.g., five, or up to a total of six) horizontal shelves 560. The two gondolas 550 (e.g., shelving units) are shown to be parallel to each other and divided by an aisle 580.

In the top view 510 of FIG. 5 a plurality of wireless communication devices in the form of ESLs 530 are shown to be mounted and installed on the horizontal shelves 560. Each of the ESLs 530 may be equipped with a display and/or a camera. A plurality of wireless communication devices in the form of ESL radios 540 are also shown to be mounted and installed on the horizontal shelves 560 and interspersed in between multiple ESLs 530. For example, as shown in FIG. 5, each ESL radio 540 is shown to be located in between three ESLs 530. In one or more examples, one or more ESLs 530 (e.g., three ESLs 530) may be associated with (e.g., linked to) a single, common, ESL radio 540. In some examples, a group of ESLs 530 may be associated with a single, common, ESL radio 540. In some examples, the ESL radios 540 may be deployed such that they are located apart from each other by a distance of one to two meters (m).

In some examples, the ESL radios 540 (e.g., which can each include a transmit and receive antenna(s)) can each be used as an “anchor node” for positioning of ambient IOT devices (e.g., ambient IOT devices 310 of FIG. 3, which may be in the form of eTags). In one or more examples, a shopping cart 570 (e.g., including an energizing device) is shown to be travelling down the aisle 580 located between the gondolas 550 (e.g., the shelving units). The shopping cart 570 may include an energizing device (e.g., an energizing devices 320 of FIG. 3) that can send (e.g., transmit) energizing signals to energize nearby ambient IOT devices (e.g., the ambient IOT deices 310 of FIG. 3, which may be in the form of eTags). After the ambient IOT devices have a sufficient amount of charge (e.g., from the energizing signals) to transmit, the ambient IOT devices may transmit beacons (e.g., beacon frames or beacon signals). The ESL radios 540 may receive the beacons from the ambient IOT devices, may obtain information from the beacons (e.g., information related to the ambient IOT devices themselves and/or information related to items or product associated with the ambient IOT devices), and may obtain measurements (e.g., signal strength measurements, such as RSSIs) of the received beacons. The ESL radios 540 may relay the information within and/or associated with (e.g., measurements, such as the RSSIs) the beacons to a network entity (e.g., the network entity 340 of FIG. 3, such as an edge server) via a network device (e.g., the network device 330 of FIG. 3, such as an access point).

In one or more examples, the network entity (e.g., the network entity 340, which may be in the form of an edge server) may determine (e.g., compute) a position (e.g., an estimated location) for an ambient IOT device (e.g., ambient IOT device 310 of FIG. 3) based on signal strengths (e.g., RSSIs) measured by the ESL radios 540 of the beacons transmitted from that ambient IOT device (e.g., ambient IOT device 310 of FIG. 3).

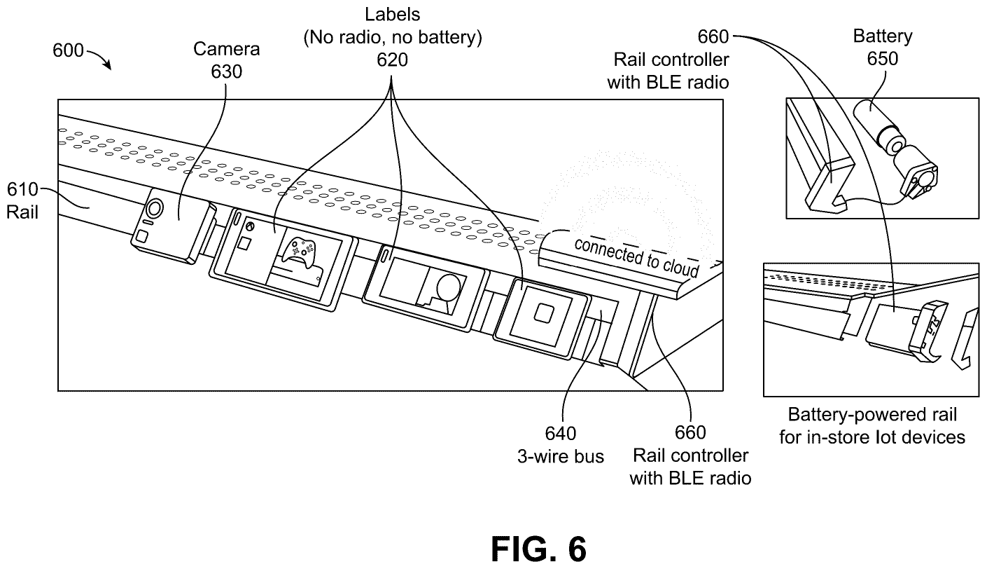

FIG. 6 shows an example wireless communication device rail. In particular, FIG. 6 is a diagram illustrating an example 600 of a wireless communication device rail 610 (e.g., an ESL rail). In one or more examples, the wireless communication device rail 610 may be installed along a shelf (e.g., one of the shelves of the horizontal shelves 560 of FIG. 5) of a shelving unit (e.g., the gondola 550 of FIG. 5) within a store or a warehouse.

In FIG. 6, the wireless communication device rail 610 is shown to include (e.g., implemented within the wireless communication device rail 610) a plurality of (e.g., three) wireless communication devices 620 (e.g., ESLs). Each of the wireless communication devices 620 is shown to include a display, which may be in the form of a light emitting diode (LED) display or an electric-paper (e-paper) display. The wireless communication devices 620 may not include a camera (e.g., an image sensor), a radio (e.g., including transmit and receive antennas), or a battery. The wireless communication device rail 610 is also shown to include a camera 630 (e.g., an image sensor), a battery 650 (e.g., used to power the wireless communication devices 620), a rail controller 660 (e.g., with a BLE radio, such as an ESL radio), and a three-wire bus 640 (e.g., for communications between the wireless communication devices 620 and the rail controller 660).

Trilateration using RSSIs for position estimation has been observed to be highly unreliable since the RSSIs are very susceptible to attenuation, which in turn can lead to poor range estimation accuracy. The Weighted Centroid Algorithm (WCA) has been seen to be much more robust to attenuation and non-line of sight (NLOS) effects.

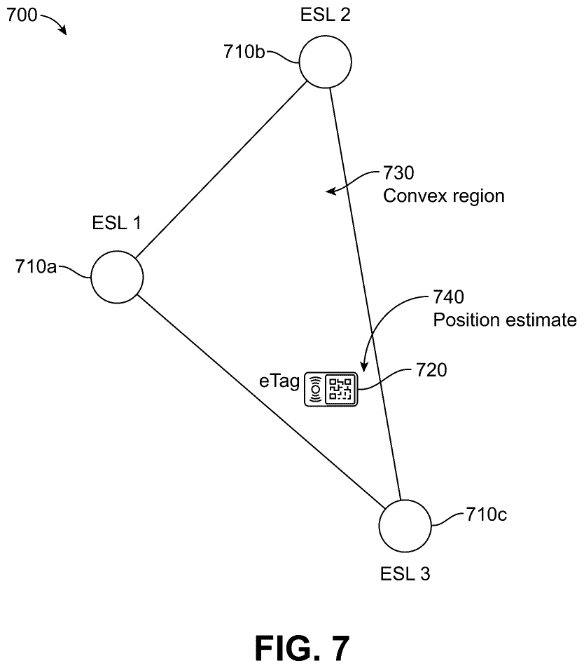

FIG. 7 shows an example of position estimation of an ambient IOT device 720 (e.g., in the form of an eTag) using an RSSI-weighted centroid algorithm (e.g., WCA). In particular, FIG. 7 is a diagram illustrating an example 700 of a convex region 730 formed by ESL radios (e.g., ESL 1 710a, ESL 2 710b, ESL 3 710c).

For example, for a given ambient IOT device (e.g., ambient IOT device 720, which may be in the form of an eTag), let r₁≥r₂≥ . . . r_{M} denote the RSSI values for M number of ESL radios (e.g., ESL 1 710a, ESL 2 710b, ESL 3 710c) in descending order. The position estimate for the ambient IOT device (e.g., ambient IOT device 720) can then be given by the weighted average of the known positions of the ESL radios (e.g., ESL 1 710a, ESL 2 710b, ESL 3 710c), where the weights may be a function of the RSSI values. As such, the position (e.g., position estimate 740) for the ambient IOT device (e.g., ambient IOT device 720) may be determined by using the following equations:

$$\hat{P} = \frac{{\sum }_{k = 1}^{N} {w}_{k} \cdot {P}_{k}}{{\sum }_{k = 1}^{N} {w}_{k}} \qquad [ equation 1 ]$$

$${w}_{k} = {2}^{\frac{{r}_{k} - {r}_{1}}{λ}} \qquad [ equation 2 ]$$

where N is the number of ESL radios (e.g., ESL 1 710a, ESL 2 710b, ESL 3 710c), wₖ are the weights for the ESL radios (e.g., ESL 1 710a, ESL 2 710b, ESL 3 710c), Pₖ are the known positions (e.g., ground truth locations) for the ESL radios (e.g., ESL 1 710a, ESL 2 710b, ESL 3 710c), and λ is a factor that determines a “priority level” for how the RSSI measurements are ranked and translated into weights. N is a subset of M. Both N and A may be empirical terms, which may be preset to some desired value.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

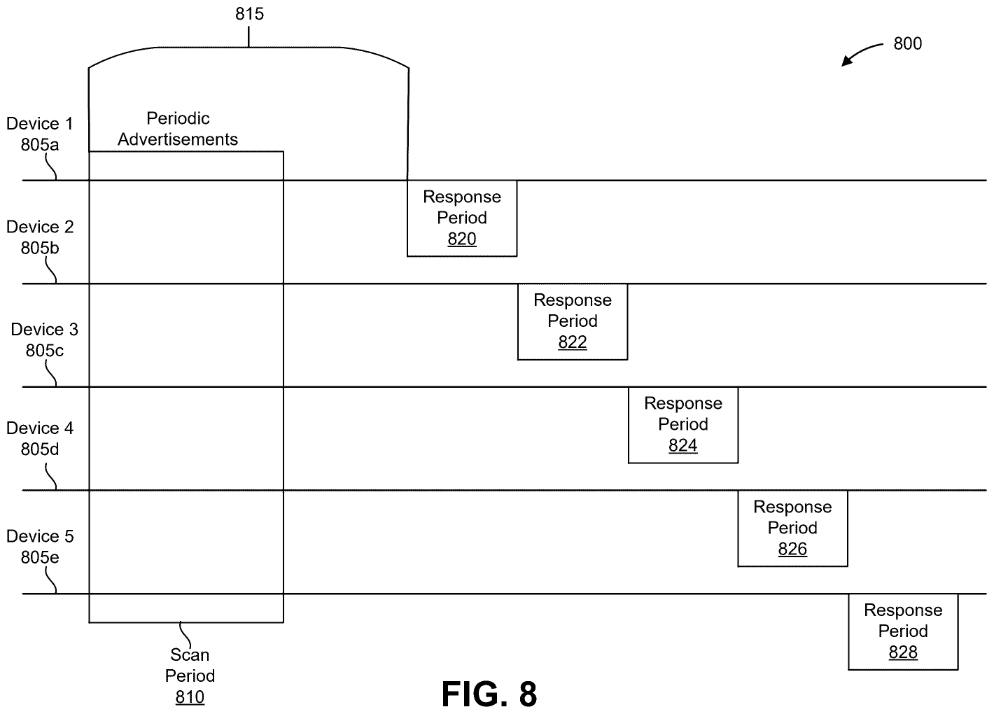

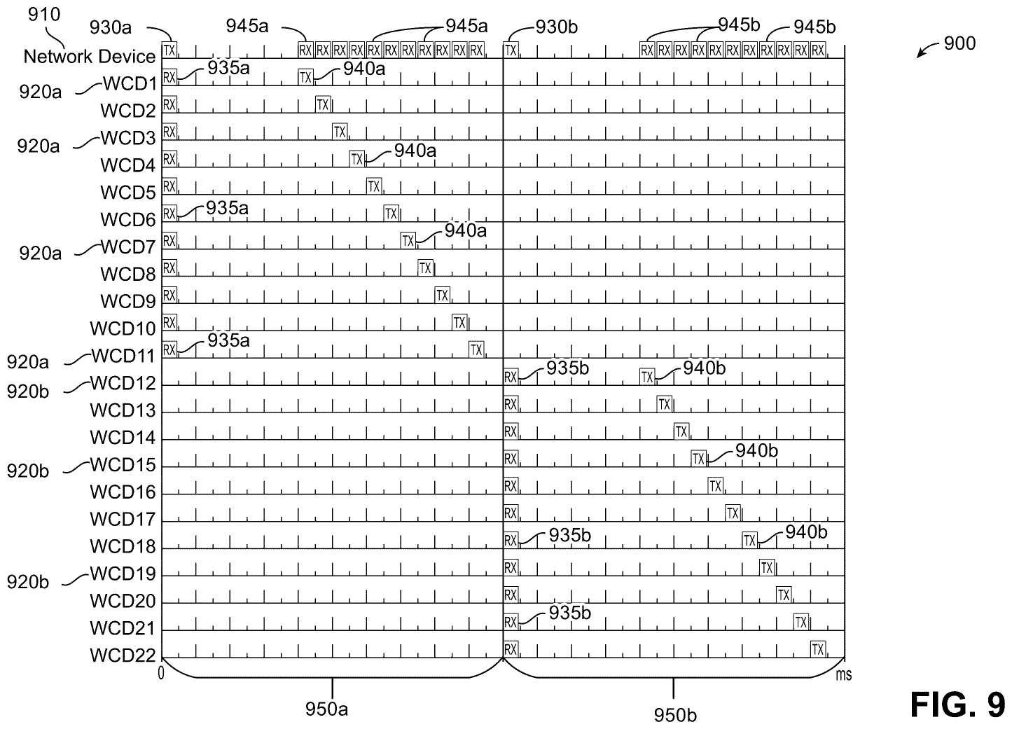

FIGS. 8 and 9 show signaling diagrams illustrating examples of PAwR in an ESL system. In particular, the signaling diagram of FIG. 8 shows an example PAwR for a group of wireless network devices (e.g., device 1 805a, device 2 805b, device 3 805c, device 4 805d, and device 5 805c), and the signaling diagram of FIG. 9 shows an example PAwR for two groups of wireless network devices 920a, 920b, shown as wireless communication devices (WCDs) (e.g., a first group including WCD1 to WCD11, and a second group including WCD 12 to WCD 22). The wireless network devices 920a, 920b can include ESLs, tags, IoT devices (e.g., ambient loT device), or other types of network devices. FIG. 8 shows a signal timing diagram illustrating a portion of a communication between an access point (e.g., access point 110) and wireless communication devices 120 (e.g., ESLs). With reference to FIG. 1, the signal sequence illustrated in FIG. 8 may be implemented by one or more of the communication connections, access points 110, and/or wireless communication devices 120 of FIG. 1.

The devices (e.g., device 1 805a, device 2 805b, device 3 805c, device 4 805d, and device 5 805c) of FIG. 8 may be selected from wireless communication devices 120 of FIG. 1, and may each receive a periodic advertisement (PA) in a scan period 810. The scan period 810 may occur in regularly scheduled intervals and may be repeated periodically such that the devices (e.g., device 1 805a, device 2 805b, device 3 805c, device 4 805d, and device 5 805c) can awaken to scan for messages during this repeated scan period 810. An access point (e.g., access point 110 of FIG. 1) may provide periodic advertisements (PAs) via broadcast or multi-cast to the devices (e.g., device 1 805a, device 2 805b, device 3 805c, device 4 805d, and device 5 805c) in the scan period 810. For an access point (e.g., access point 110 of FIG. 1), the scan period 810 can be its primary transmission period. In some cases, the scan period 810 may not be a fixed time because the access point (e.g., access point 110 of FIG. 1) may send different lengths of data from the start of the scan period 810.

The transmission may include multiple advertisements in a train. One or more portions of the advertisements may be directed to one or more of the devices (e.g., device 1 805a, device 2 805b, device 3 805c, device 4 805d, and device 5 805c). The devices (e.g., device 1 805a, device 2 805b, device 3 805c, device 4 805d, and device 5 805c) may decode or filter the messages intended for each specific device and transmitted during the period when all devices are receiving. In this way, the devices (e.g., device 1 805a, device 2 805b, device 3 805c, device 4 805d, and device 5 805e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 805a, device 2 805b, device 3 805c, device 4 805d, and device 5 805c).

As illustrated, the devices (e.g., device 1 805a, device 2 805b, device 3 805c, device 4 805d, and device 5 805e) are each assigned a response period 820, 822, 824, 826, 828 in the time after the scan period 810. The response periods 820, 822, 824, 826, 828 for the peripheral (e.g., ESL, tag, IoT device, etc.) transmissions occur in a time division multiple access (TDMA) manner. In some cases, the assignment of the response period to a particular device may not be permanent. In some aspects, the assignment may be inferred from a payload of a synchronization message. The first response period 820 may begin following an idle time 815 after the scan period 810, with the idle period being long enough to provide the transmitter device an opportunity to do other Bluetooth related activities. The assigned response periods may also be limited to or designate a particular frequency of the channels on which to respond. For example, in FIG. 8, device 1 805a is assigned response period 820, device 2 805b is assigned response period 822, device 3 805c is assigned response period 824, device 4 805d is assigned response period 826, and device 5 805e is assigned response period 828. The access point (e.g., access point 110 of FIG. 1) may store attributes of the devices (e.g., device 1 805a, device 2 805b, device 3 805c, device 4 805d, and device 5 805c), including whether a device is able to transmit or respond. The PA signaling followed by responses can be referred to as periodic advertisement with multiple responses (PAwMR).

For example, device 3 805c (e.g., wireless communication device 120 of FIG. 1) may be a peripheral device (e.g., an ESL or other device) and may receive a price update in a PA from the access point (e.g., access point 110 of FIG. 1) in scan period 810. The PA received at device 3 805c may include a designated start time for the response period 824 or may include a schedule of response start times for devices including device 3 805c. The response by device 3 805c to the access point (e.g., access point 110 of FIG. 1) may include an acknowledgement, a status code, and/or other information such as battery life, received signal strength, and/or an error notification. The response by device 3 805c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 805a, device 2 805b, device 3 805c, device 4 805d, and device 5 805c) may use channels of the Bluetooth protocol.

A device (e.g., device 5 805e) that has been assigned a response period may not respond and may determine that it has nothing to signal. In other words, the devices (e.g., device 1 805a, device 2 805b, device 3 805c, device 4 805d, and device 5 805e) may determine what response, if any, is required and may or may not respond to a request sent from the access point (e.g., access point 110 of FIG. 1). The response periods 820, 822, 824, 826, 828 may be assigned based on a request for such a period in an open transmission time, the request being sent to the access point (e.g., access point 110 of FIG. 1). The response periods 820, 822, 824, 826, 828 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 9 shows an example PAwR for two groups of wireless network devices 920a, 920b (e.g., a first group including WCD1 to WCD 11, and a second group including WCD 12 to WCD 22). In particular, FIG. 9 is a signaling diagram illustrating an example of communication transmissions 900 between a network device 910 (e.g., a central device, which may be an access point) and two groups of wireless communication devices 920a, 920b (e.g., peripheral devices, which may be ESLs). With reference to FIG. 1, the signal sequence illustrated in FIG. 9 may be implemented by one or more of the communication connections, access points 110, and/or wireless communication devices 120 of FIG. 1.

In FIG. 9, the signaling diagram is shown in the form of a graph (e.g., a time grid, which may be predetermined) with an x-axis denoting time in milliseconds (ms) and a y-axis denoting specific wireless communication devices 920a, 920b (e.g., WCD1, WCD 2, WCD 3, WCD 4, WCD 5, WCD 6, WCD 7, WCD 8, WCD 9, WCD 10, WCD 11, WCD 12, WCD 13, WCD 14, WCD 15, WCD 16, WCD 17, WCD 18, WCD 19, WCD 20, WCD 21, and WCD 22). In particular, the x-axis of the graph of FIG. 9 denotes time starting from zero (0) ms. The time can be divided into two subframes 950a, 950b. As such, the two subframes 950a, 950b may include a first subframe 950a and a second subframe 950b. In one or more examples, there may be more or less than two subframes 950a, 950b as is shown in FIG. 9, and/or each subframe 950a, 950b may be longer or shorter than as shown in FIG. 9.

In one or more examples, the wireless communication devices 920a, 920b (e.g., peripheral devices) may be assigned (e.g., by the network device 910 and/or by a network entity, such as a management entity) to different groups (e.g., two groups) of wireless communication devices 920a, 920b. For example, wireless communication devices 920a (e.g., WCD1, WCD 2, WCD 3, WCD 4, WCD 5, WCD 6, WCD 7, WCD 8, WCD 9, WCD 10, and WCD 11) may be assigned to a first group (e.g., group 1), and wireless communication devices 920b (e.g., WCD 12, WCD 13, WCD 14, WCD 15, WCD 16, WCD 17, WCD 18, WCD 19, WCD 20, WCD 21, and WCD 22) may be assigned to second group (e.g., group 2).

In FIG. 9, during operation for PAwR, at time 0 ms for the first subframe 950a of time, the network device 910 (e.g., a central, such as an AP) may transmit 930a to a first group (e.g., group 1) of wireless communication devices 920a (e.g., WCD1, WCD 2, WCD 3, WCD 4, WCD 5, WCD 6, WCD 7, WCD 8, WCD 9, WCD 10, and WCD 11) a PA containing a synchronization message (e.g., an AP synchronization message) over a synchronized channel between the network device 910 and the wireless communication devices 920a, 920b. As noted previously, a synchronization message can include one or more commands. For instance, a command can include an operational code (OpCode) and parameters associated with the command. At time 0 ms, the first group of wireless communication devices 920a (e.g., WCD1, WCD 2, WCD 3, WCD 4, WCD 5, WCD 6, WCD 7, WCD 8, WCD 9, WCD 10, and WCD 11) can receive 935a the PA containing the synchronization message over the synchronized channel.

In one or more examples, the network device 910 may be configured to transmit PAs at a specified time interval (e.g., a subframe of time), such as is shown in FIG. 9. In one or more examples, the specified time interval (e.g., a subframe) may be shorter or longer than the as is shown in FIG. 9. The wireless communication devices 920a, 920b may respond to a PA by using their specific respective response slot in time.

In one or more examples, the synchronization message transmitted 930a to the first group (e.g., group 1) of wireless communication devices 920a (e.g., WCD1, WCD 2, WCD 3, WCD 4, WCD 5, WCD 6, WCD 7, WCD 8, WCD 9, WCD 10, and WCD 11) may indicate a respective response slot for one or more of the wireless communication devices 920a (e.g., WCD 1, WCD 2, WCD 3, WCD 4, WCD 5, WCD 6, WCD 7, WCD 8, WCD 9, WCD 10, and/or WCD 11) in the first group to use to transmit 940a a response to the network device 910. If a wireless communication device 920a (e.g., WCD1, WCD 2, WCD 3, WCD 4, WCD 5, WCD 6, WCD 7, WCD 8, WCD 9, WCD 10, and WCD 11) is addressed within the synchronization message, the wireless communication device 920a (e.g., WCD1, WCD 2, WCD 3, WCD 4, WCD 5, WCD 6, WCD 7, WCD 8, WCD 9, WCD 10, and WCD 11) can respond (e.g., transmit 940a) in its respective response slot, as indicated within the synchronization message. For example, the synchronization message may indicate a specific sequence for one or more of the wireless communication devices 920a (e.g., WCD 1, WCD 2, WCD 3, WCD 4, WCD 5, WCD 6, WCD 7, WCD 8, WCD 9, WCD 10, and/or WCD 11) to respond (e.g., transmit 940a) in time (e.g., responding after 5 ms has elapsed after the start of the subframe 950a at response slots as shown in FIG. 9).

After the wireless communication devices 920a (e.g., WCD1, WCD 2, WCD 3, WCD 4, WCD 5, WCD 6, WCD 7, WCD 8, WCD 9, WCD 10, and WCD 11) have received 935a the PA containing the synchronization message from the network device 910, according to the sequence specified within the synchronization message, the one or more wireless communication devices 920a (e.g., WCD 1, WCD 2, WCD 3, WCD 4, WCD 5, WCD 6, WCD 7, WCD 8, WCD 9, WCD 10, and/or WCD 11) can transmit 940a their responses within their respective response slots. After the one or more wireless communication devices 920a (e.g., WCD 1, WCD 2, WCD 3, WCD 4, WCD 5, WCD 6, WCD 7, WCD 8, WCD 9, WCD 10, and/or WCD 11) have transmitted 940a their responses in their respective response time slots, the network device 910 can receive 945a their transmitted responses at those specific response slot times.

During operation for PAwR, for the second subframe 950b of time, the network device 910 may transmit 930b to a second group (e.g., group 2) of wireless communication devices 920b (e.g., WCD 12, WCD 13, WCD 14, WCD 15, WCD 16, WCD 17, WCD 18, WCD 19, WCD 20, WCD 21, and WCD 22) a PA containing a synchronization message over a synchronized channel between the network device 910 and the wireless communication devices 920a, 920b. In addition, at the start of the second subframe 950b, the second group of wireless communication devices 920b (e.g., WCD 12, WCD 13, WCD 14, WCD 15, WCD 16, WCD 17, WCD 18, WCD 19, WCD 20, WCD 21, and WCD 22) can receive 935b the PA containing the synchronization message over the synchronized channel.

The synchronization message transmitted 930b to the second group (e.g., group 2) of wireless communication devices 920b (e.g., WCD 12, WCD 13, WCD 14, WCD 15, WCD 16, WCD 17, WCD 18, WCD 19, WCD 20, WCD 21, and WCD 22) may indicate a respective response slot for one or more of the wireless communication devices 920b (e.g., WCD 12, WCD 13, WCD 14, WCD 15, WCD 16, WCD 17, WCD 18, WCD 19, WCD 20, WCD 21, and/or WCD 22) in the second group to use to transmit 940b a response to the network device 910. If a wireless communication device 920b (e.g., WCD 12, WCD 13, WCD 14, WCD 15, WCD 16, WCD 17, WCD 18, WCD 19, WCD 20, WCD 21, and WCD 22) is addressed within the synchronization message, the wireless communication device 920b (e.g., WCD 12, WCD 13, WCD 14, WCD 15, WCD 16, WCD 17, WCD 18, WCD 19, WCD 20, WCD 21, and WCD 22) can respond (e.g., transmit 940b) in its respective response slot, as indicated within the synchronization message. For example, the synchronization message may indicate a specific sequence for one or more of the wireless communication devices 920b (e.g., WCD 12, WCD 13, WCD 14, WCD 15, WCD 16, WCD 17, WCD 18, WCD 19, WCD 20, WCD 21, and/or WCD 22) to respond (e.g., transmit 940b) in time (e.g., responding after 5 ms has elapsed after the start of the subframe at response slots as shown in FIG. 9).

After the wireless communication devices 920b (e.g., WCD 12, WCD 13, WCD 14, WCD 15, WCD 16, WCD 17, WCD 18, WCD 19, WCD 20, WCD 21, and WCD 22) have received 935b the PA containing the synchronization message from the network device 910, according to the sequence specified within the synchronization message, the one or more wireless communication devices 920b (e.g., WCD 12, WCD 13, WCD 14, WCD 15, WCD 16, WCD 17, WCD 18, WCD 19, WCD 20, WCD 21, and/or WCD 22) may transmit 940b their responses within their respective response slots. After the one or more wireless communication devices 920b (e.g., WCD 12, WCD 13, WCD 14, WCD 15, WCD 16, WCD 17, WCD 18, WCD 19, WCD 20, WCD 21, and/or WCD 22) have transmitted 940b their responses in their respective response time slots, the network device 910 can receive 945b their transmitted responses at those specific response slot times. The PAwR may continue similarly for subsequent subframes of time.

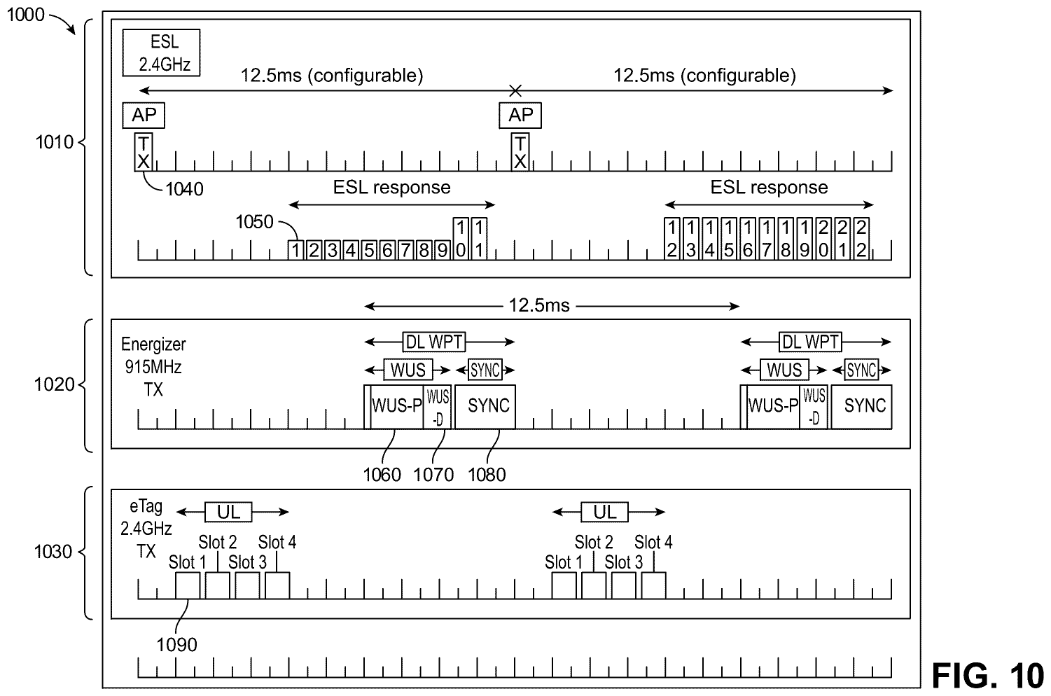

FIG. 10 shows examples of scheduling as per the Bluetooth specification as well as per custom energizing device/eTag scheduling. In particular, FIG. 10 is a signaling diagram illustrating examples 1000 of communication transmissions 1010, 1020, 1030. Communication transmissions 1010 shows scheduling (e.g., for communications between a network device in the form of an access point and ESLs equipped with radios) per the Bluetooth specification, communication transmissions 1020 shows custom scheduling for an energizing device, and communication transmissions 1020 shows custom scheduling for ambient IOT devices (e.g., eTags).

For the communications 1010 of FIG. 10, an access point can send an AP beacon 1040 (e.g., including an AP_SYNC) once every periodic advertisement interval of 1.6 seconds(s). There may be a total of 128 subevent intervals, each 12.5 milliseconds (ms) long to address the ESLs. The ESLs may be grouped within in 128 groups. An ESL group can include eleven ESLs, which may transmit within a 12.5 ms subframe. There may be a maximum of 128 groups being managed by a single access point, for a total of 1408 ESLs, which may transmit within a 1.6 s frame.

In one or more examples, the AP beacon 1040 can include control information indicating when the ESLs should wake up to listen, and when each specific ESL should transmit a response to the access point. The ESLs may be synchronized with the access point. Each ESL can wake up once every 1.6 s to listen for the AP beacon 1040 in the subevent matching its own group ID (from 0 to 127). The ESLs can send responses within the response slots 1050 (e.g., eleven response slots) assigned to the eleven different ESLs. This signaling pattern can repeat over a certain period of time, until the access point receives responses from all of the ESLs.

For the communications 1030, the ambient IOT devices (e.g., eTags) may randomly select one of the four time slots 1090, which occur in time (e.g., over a duration of 3.75 ms) between the AP beacon 1040 and the response slots 1050, to transmit an UL beacon. Each time slot may be larger than the duration of the UL beacon to account for the possibility of poor time synchronization. These time slots repeat every subframe (e.g., of 12.5 ms).

For the communications 1020, energizing devices can transmit a DL signal (e.g., every subframe) that may be an energizing signal that energizes ambient IOT devices (e.g., eTags). The DL signal can include a wakeup signal (WUS) and a synchronization waveform (SYNC) 1080. The WUS can include a wakeup signal-packet (WUS-P) 1060 and wakeup signal-data (WUS-D) 1070. The WUS-D 1070 can include control information indicating the four time slots 1090 that the ambient IOT devices (e.g., eTags) may choose from to transmit an UL beacon to the ESLs. The control information may be in the form of a bitmap, which can be used to relay the control information to the ambient IOT devices (e.g., eTags). The synchronization waveform (SYNC) 1080 can be used by the ambient IOT devices (e.g., eTags) to determine the start time and end time of each of the four time slots 1090.

In one or more aspects, the systems and techniques provide a solution for wireless communication device (e.g., ESL) transmit and receive patterns for energy-efficient positioning. The system and techniques focus on wireless communication device (e.g., ESL) radio power conservation. In one or more examples, the systems and techniques optimize a trade-off between position accuracy and power consumption in the form of transmit and/or receive patterns that are imposed on wireless communication device (e.g., ESL) radio operations.

In one or more aspects, during operation for wireless communications at a network entity, the network entity may determine a group of wireless communication device (e.g., ESL) radios of a plurality of wireless communication device radios for positioning a target device. The network entity may determine, based on criteria, a communications pattern for the group of wireless communication device radios. The network entity may transmit, to the group of wireless communication device radios, an indication of the communications pattern to use for communications with the target device for positioning the target device.

In one or more examples, determining the group of wireless communication device radios of the plurality of wireless communication device radios may be based on a known area comprising the target device (e.g., a known coarse location of the target device). In some examples, the criteria may include confidence in a location estimate of the target device, a time of day, foot traffic for an area comprising the target device, an accuracy requirement associated with a use case for the target device, a buffer capacity for each wireless communication device radio of the plurality of wireless communication device radios, presence of an uplink interference, and/or a use case associated with an identifier of the target device.

In one or more examples, the target device may be an ambient IOT device or a mobile device. In some examples, when the target device is an ambient IOT device, the communications pattern may be a receive pattern for the group of wireless communication device radios to receive from the target device. In one or more examples, the ambient IOT device may be an energy harvesting electronic tag (etag).

In some examples, when the target device is a mobile device, the communications pattern may be a transmit pattern for the group of wireless communication device radios to transmit to the target device. In one or more examples, the network entity may group wireless communication device radios within the group of wireless communication device radios into a plurality of clusters. In some examples, the wireless communication device radios within each cluster of the plurality of clusters may have a uniform spatial geometry. In one or more examples, the communications pattern may include staggered transmissions across time for the wireless communication device radios within each cluster of the plurality of clusters and/or for wireless communication device radios across different clusters of the plurality of clusters. In some examples, the mobile device may be smartphone, a smart watch, or a tablet. In one or more examples, the network entity may be a management entity (e.g., edge server). In some examples, each wireless communication device radio of the plurality of wireless communication device radios may be an electronic shelf label (ESL) radio.

In one or more aspects, for an example scenario for positioning a target device, the target device (e.g., such as a mobile device, for example a smartphone, smart watch, or tablet, which may be associated with a user) may receive beacons (e.g., which may be transmitted in time between the AP beacon 1040 of FIG. 10 and the response slots 1050 of FIG. 10) from wireless communication device radios (e.g., ESL radios 540 of FIG. 5). The target device may then measure the RSSIs of the received beacons and estimate its own position (or report the measurements to a network entity, such as network entity 340 of FIG. 3, which may in turn estimate the position of the target device and transmit the estimated position back to the target device).

In one or more examples, during operation of the systems and techniques for positioning a target device (e.g., a mobile device, such as a smart phone, which may be associated with a user), the network entity (e.g., network entity 340 of FIG. 3, which may be in the form of an edge server) may select a first group of wireless communication device radios (e.g., ESL radios 540 of FIG. 5) for transmitting a beacon (e.g., which may be intended to be used for positioning by the target device) using a first transmit pattern (e.g., a communications pattern). If available, a known coarse location (e.g., an area) for the target device may be used by the network entity (e.g., edge server) to select a smaller group of wireless communication device radios located in the vicinity of the target device (e.g., located nearby the known coarse location of the target device). The known course location can be based on any type of location information, such as GNSS or GPS information, a location indicated by a network device (e.g., a base station, an access point, a server, etc.) in communication with the target device.

The network entity (e.g., edge server) may select one transmit pattern of a plurality of transmit patterns. The network entity can then send an indication to the determined first group of wireless communication device radios to transmit beacons according to the selected transmit pattern. In one or more examples, the network entity can send the indication to the first group of wireless communication device radios via one or more network devices (e.g., such as network device 330 of FIG. 3, which may be in the form of an access point) that can transmit the indication within an AP beacon (e.g., AP beacon 1040 of FIG. 10), such as within an AP_SYNC packet within the AP beacon.

After receiving the indication, the first group of wireless communication device radios may be configured according to the indication of the transmit pattern. The network entity (e.g., edge server) can also send an indication of the selected transmit pattern to the target device, which can use this information to listen at the correct time slots for the beacons from the first group of wireless communication device radios and receive the beacons. After receiving the beacons from the first group of wireless communication device radios, the target device can measure (e.g., measure signal strengths, such as RSSIs) the beacons. The target device may use these measurements to determine an estimated position for the target device. The target device may then send (e.g., report) the measurements (e.g., RSSI measurements) and/or the estimated position of the target device back to the network entity (e.g., edge server).

After receiving the measurements (e.g., RSSI measurements) and/or the estimated position, the network entity (e.g., edge server) may select a second group of wireless communication device (e.g., ESL) radios for transmitting beacons using a second transmit pattern. The second group of wireless communication device radios may contain a lesser number of wireless communication device radios than the first group of wireless communication device radios. The second group of wireless communication device radios may be selected by the network entity based on their proximity to the target device or based on a function of the signal strength (e.g., RSSIs) of the beacons from the wireless communication device radios. In one or more examples, the transmit pattern may be changed based on certain criteria, which will be discussed below. In one or more examples, the process for positioning of the target device can be repeated as described, where subsequent smaller groups of wireless communication device (e.g., ESL) radios may be selected by the network entity (e.g., edge server) for refining the positioning estimate of the target device.

In one or more aspects, as opposed to selecting (e.g., by a network entity, such as an edge server) an entire group wireless communication device (e.g., ESL) radios to transmit beacons, a transmit pattern may be imposed such that the number of beacon transmissions (e.g., by the wireless communication device radios) is reduced (e.g., thereby consequently reducing power consumption by the wireless communication devices) without degrading the positioning accuracy by much.

In one or more examples, a staggered pattern (e.g., transmit pattern) may be used for the wireless communication device radios. In some examples, the pattern for the wireless communication device radios may be staggered across both space and time.

In one or more examples, a network entity (e.g., edge server) may group wireless communication device (e.g., ESL) radios into clusters by spatial interleaving. The wireless communication device radios may be grouped into clusters to form a uniform spatial geometry of the wireless communication device radios (e.g., such that the wireless communication device radios may be uniformly spaced from one another) and to stagger the transmissions of the wireless communication device radios across time (e.g., such that different wireless communication device radios transmit at different times across time). As such, the clusters may be assigned certain respective time slots to transmit. In one or more examples, an additional duty cycle for transmissions (e.g., indicating how often transmissions will occur) may be assigned for each of the clusters. For instance, each of the clusters will skip a number of time slots for transmission based on the duty cycle. In one illustrative example, for a duty cycle of one-hundred (100) percent (%), there will be beacon transmissions by the clusters for all of the time slots (e.g., all 512 time slots). In another illustrative example, for a duty cycle of fifty (50) %, there will be beacon transmissions by the clusters for only half of the time slots (e.g., 512/2=256 time slots).

In one or more examples, two parameters, which may include cluster size and cluster duty cycle, may be used to describe the pattern (e.g., transmit pattern). In one illustrative example of a pattern over 512 time slots, a cluster may have a cluster size of 50 wireless communication device (e.g., ESL) radios and a duty cycle of 100%. A first cluster of wireless communication device radios may include wireless communication device radios with identifiers (e.g., ID numbers, or MAC addresses) that are odd numbered (e.g., 1, 3, 5, 7, . . . 99) and will transmit over odd numbered time slots (e.g., 1, 3, 5, 7, . . . 511). A second cluster of wireless communication device radios may include wireless communication device radios with identifiers that are even numbered (e.g., 2, 4, 6, 8, . . . 100) and will transmit over even numbered time slots (e.g., 2, 4, 6, 8, . . . 512).

In another illustrative example of a pattern over 512 time slots, a cluster may have a cluster size of 50 wireless communication device radios and a duty cycle of 50%. A first cluster of wireless communication device radios may include wireless communication device radios with identifiers that are odd numbered (e.g., 1, 3, 5, 7, . . . 99) and will transmit over time slots 1, 5, 9, . . . 511. A second cluster of wireless communication device radios may include wireless communication device radios with identifiers that are even numbered (e.g., 2, 4, 6, 8, . . . 100) and will transmit over time slots 2, 6, 10, . . . 512.

In another illustrative example of a pattern over 512 time slots, a cluster may have a cluster size of twenty (20) wireless communication device radios and a duty cycle of ten (10) %. A first cluster of wireless communication device radios may include wireless communication device radios with identifiers of 1, 6, 11, . . . 96, and will transmit over time slots 1, 51, 101, 151 . . . 501. A second cluster of wireless communication device radios may include wireless communication device radios with identifiers of 2, 7, 12, . . . 97, and will transmit over time slots 2, 52, 102, 152, . . . 502. A third cluster of wireless communication device radios may include wireless communication device radios with identifiers of 3, 8, 13, . . . 98, and will transmit over time slots 3, 53, 103, 153, . . . 503.

Battery life for a wireless communication device (e.g., ESL) radio within a cluster can be reduced by reducing a size of the cluster and/or a duty cycle. In one illustrative example, by reducing the cluster size from 100 to 4, the battery life of the wireless communication devices in the cluster can be extended by up to 40%. Similarly, by reducing the duty cycle from 100% to 25%, the battery life can be extended by up to 29% . . . .

In one or more aspects, when the impact to the battery life of a wireless communication device (e.g., ESL) radio is lower, naturally, the number of time slots during which the wireless communication device (e.g., ESL) radio is operating is lower, which in turn can degrade the accuracy of a position estimate of a target device. As such, this approach involves a trade-off (e.g., between cluster size and duty cycle).

In order to achieve a balance between the two (e.g., cluster size and duty cycle), a time interval or periodicity may be imposed on switching between multiple patterns (e.g., communications patterns). In some examples, the patterns may change periodically to achieve better location accuracy at some times, and then prioritize power consumption at other times.

For example, a pattern A (e.g., with a cluster size of 50 and a duty cycle of 100%) is power intensive, but can achieve better location accuracy than less power intensive patterns. A pattern C (e.g., with a cluster size of 5 and a duty cycle of 10%) can conserve battery power of the wireless communication device (e.g., ESL) radios, but the positioning accuracy will be degraded. As such, pattern C may be used for a continuous period of time (e.g., two minutes). After the two minutes has elapsed, pattern A may be used for another period of time (e.g., thirty seconds). After the thirty seconds has elapsed, pattern C may be used again. In one or more examples, multiple different patterns and/or periodicities may be used.

In one or more examples, a certain pattern (e.g., communications pattern) can be chosen in an on-demand manner, based on certain criteria. In one or more examples, the criteria may include a confidence in the location estimate. For example, if the target device reports a confidence metric that is below (or above) a confidence threshold (e.g., a threshold value of 0.8, 0.85, 0.9, etc.), the network entity (e.g., edge server) may change the pattern to improve (or degrade) the position accuracy, as needed. Additionally or alternatively, in some examples, the criteria may include a time of day and/or an amount of foot traffic. For example, during certain times of the day, there may be a larger number of people within an environment (e.g., a retail store, warehouse, etc.) and, as such, a more power-intensive pattern may need to be used. Additionally or alternatively, in some cases, the criteria may include a use case and associated accuracy requirement. For example, for indoor navigation, a position estimate accuracy of at least one meter or lower can be desirable. Conversely, for asset tracking of low-value objects (e.g., products), a position estimate accuracy of five meters may be tolerable. Additionally or alternatively, in some examples, the criteria may include a wireless communication device (e.g., ESL) radio buffer capacity. For example, the number of target device (e.g., an ambient IOT device, such as an etag) RSSI reports that may be stored by a wireless communication device (e.g., ESL) radio (e.g., until the wireless communication device (e.g., ESL) radio can report all of the data to the network device, such as an access point) is limited by the wireless communication device (e.g., ESL) radio buffer size. As such, only certain patterns may be able to meet this buffer size requirement.

In one or more aspects, for an example scenario for positioning a target device, the target device (e.g., such as an ambient IOT device, such as an energy harvesting etag) may be traveling (e.g., moving) along an aisle (e.g., within a retail store or warehouse) whose position is to be estimated using wireless communication device (e.g., ESL) radios as anchor nodes. For this example, the target device can transmit a beacon that is received and measured (e.g., RSSI measurement) by the wireless communication device radios. In one or more examples, the same methodology for selection and indication of a pattern as previously discussed (e.g., for the example scenario where the target device is a mobile device, such as a mobile phone) may be used for this example scenario (e.g., where the target device is an etag), except that the wireless communication device radios will follow the selected pattern for reception, not transmission. Receive patterns (e.g., communications patterns) can be important because it is not known when the ambient IOT devices (e.g., etags) will transmit beacons and, as such, these receive patterns can allow for the network to randomly scan and detect transmissions from ambient IOT devices (e.g., etags) to use for position estimation. In one or more examples, the receive pattern may be restricted to only uplink (UL) time slots (e.g., a total of 512 UL time slots in a cycle) that are reserved for ambient IOT device (e.g., etag) transmissions.

In one or more examples, in addition to the previously mentioned criteria for pattern selection, some additional metrics (e.g., additional criteria) may be utilized to select a certain pattern (e.g., receive pattern) in the case of UL-RSSI based ambient IOT device positioning. In one or more examples, the additional metrics may include the presence of UL interference. For example, the presence of interference can be inferred at the wireless communication device (e.g., ESL) radios (and energizing devices as well) when two ore more ambient IOT device (e.g., etag) transmissions appear to be garbled and of similar signal strength (e.g., RSSI). When the average rate of such collisions is seen to be above a certain collision threshold, a larger cluster size and/or a higher duty cycle may be selected to form the receive pattern. Forming the receive pattern based on a larger cluster size and/or a higher duty cycle will allow for more reception time slots during which interference may occur less frequently.

In some examples, the additional metrics may involve the use case and associated ambient IOT device (e.g., etag) ID. For example, an ambient IOT device (e.g., etag) ID may be mapped to its intended use case (e.g., item restocking or anti-theft tracking for valuable objects). For the use case of item restocking, only the final static location of the ambient IOT device (e.g., etag) may be desired and, as such, a highly power-conserving pattern may be used over extended periods of time to achieve the desired positioning. For the use case of anti-theft tracking for valuable objects, a more power-intensive pattern may be used by wireless communication device (e.g., ESL) radios located (e.g., installed) nearby the valuable objects.

In one or more aspects, for an example scenario for positioning a target device in the form of a mobile device (e.g., a smartphone associated with a user), the wireless communication device radios may transmit beacons that may be received by the target device (e.g., mobile phone). The vice versa occurs when the target device is in the form of an ambient IOT device (e.g., etag), where the wireless communication device radios instead receive beacons transmitted from the target device (e.g., etag).

In some cases, in an example scenario for positioning of target devices in the form of mobile devices (e.g., smartphones) and ambient IOT devices (e.g., etags) that are present within an aisle (e.g., of a retail store or warehouse), the wireless communication device radios can use two patterns, which include a transmit pattern and a receive pattern. In one or more examples, using two patterns may be power-intensive for the wireless communication device radios. As such, additional changes may be made to the patterns (e.g., transmit pattern and receive pattern) to conserve battery power for the wireless communication device radios. In one or more examples, when the ratio of the number of ambient IOT devices (e.g., etags) to the number of mobile devices (e.g., smartphones) within a certain region (e.g., an aisle or a 20-by-20 meter area) exceeds a number threshold value, the wireless communication device radios may use a more power-intensive receive pattern and a less power-intensive transmit pattern. Conversely, in some examples, when the ratio of the number of ambient IOT devices (e.g., etags) to the number of mobile devices (e.g., smartphones) within a certain region (e.g., an aisle or a 20-by-20 meter area) does not exceed the number threshold value, the wireless communication device radios may use a less power-intensive receive pattern and a more power-intensive transmit pattern.

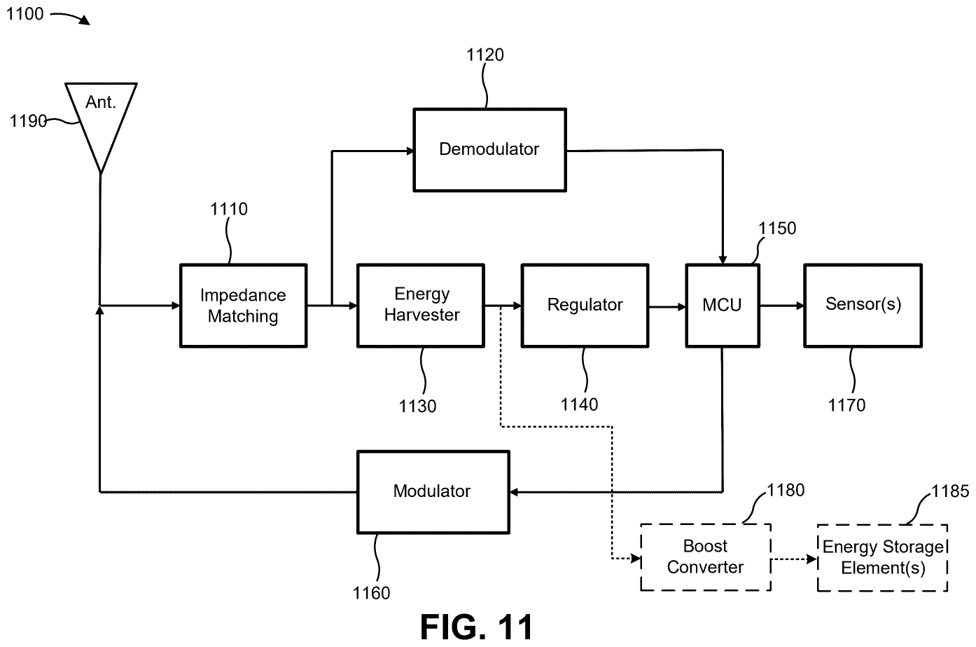

FIG. 11 is a diagram illustrating an example of an architecture of a radio frequency (RF) energy harvesting device 1100, in accordance with some examples. As will be described in greater depth below, the RF energy harvesting device 1100 can harvest RF energy from one or more RF signals received using an antenna 1190. As used herein, the term “energy harvesting” may be used interchangeably with “power harvesting.” In some aspects, energy harvesting device 1100 can be implemented as an Internet-of-Things (IOT) device, can be implemented as a sensor, etc., as will be described in greater depth below. In other examples, energy harvesting device 1100 can be implemented as a Radio-Frequency Identification (RFID) tag or various other RFID devices.

The energy harvesting device 1100 includes one or more antennas 1190 that can be used to transmit and receive one or more wireless signals. For example, energy harvesting device 1100 can use antenna(s) 1190 to receive one or more downlink signals and to transmit one or more uplink signals. An impedance matching component 1110 can be used to match the impedance of antenna(s) 1190 to the impedance of one or more (or all) of the receive components included in energy harvesting device 1100. In some examples, the receive components of energy harvesting device 1100 can include a demodulator 1120 (e.g., for demodulating a received downlink signal), an energy harvester 1130 (e.g., for harvesting RF energy from the received downlink signal), a regulator 1140, a micro-controller unit (MCU) 1150, a modulator 1160 (e.g., for generating an uplink signal). In some cases, the receive components of energy harvesting device 1100 may further include one or more sensors 1170.

The downlink signals can be received from one or more transmitters. For example, energy harvesting device 1100 may receive a downlink signal from a network node or network entity that is included in a same wireless network as the energy harvesting device 1100. In some cases, the network entity can be a base station, gNB, etc., that communicates with the energy harvesting device 1100 using a cellular communication network. For example, the cellular communication network can be implemented according to the 3G, 4G, 5G, and/or other cellular standard (e.g., including future standards such as 6G and beyond).

In some cases, energy harvesting device 1100 can be implemented as a passive or semi-passive energy harvesting device (e.g., an ambient energy harvesting device), which can perform passive uplink communication by modulating and reflecting a downlink signal received via antenna(s) 1190. For example, passive and semi-passive energy harvesting devices may be unable to generate and transmit an uplink signal without first receiving a downlink signal that can be modulated and reflected. In other examples, energy harvesting device 1100 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 1185 (e.g., collectively referred to as an “energy reservoir”). For example, the one or more energy storage elements 1185 can include batteries, capacitors, etc. In some examples, the one or more energy storage elements 1185 may be associated with a boost converter 1180. The boost converter 1180 can receive as input at least a portion of the energy harvested by energy harvester 1130 (e.g., with a remaining portion of the harvested energy being provided as instantaneous power for operating the energy harvesting device 1100). In some aspects, the boost converter 1180 may be a step-up converter that steps up voltage from its input to its output (e.g., and steps down current from its input to its output). In some examples, boost converter 1180 can be used to step up the harvested energy generated by energy harvester 1130 to a voltage level associated with charging the one or more energy storage elements 1185. An ambient energy harvesting device (e.g., active or semi-passive energy harvesting device) may include one or more energy storage elements 1185 and may include one or more boost converters 1180. A quantity of energy storage elements 1185 may be the same as or different than a quantity of boost converters 1180 included in an active or semi-passive energy harvesting device.

A passive energy harvesting device does not include an energy storage element 1185 or other on-device power source. For example, a passive energy harvesting device may be powered using only RF energy harvested from a downlink signal (e.g., using energy harvester 1130). As mentioned previously, a semi-passive energy harvesting device can include one or more energy storage elements 1185 and/or other on-device power sources. The energy storage element 1185 of a semi-passive energy harvesting device can be used to augment or supplement the RF energy harvested from a downlink signal. In some cases, the energy storage element 1185 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 1185 and/or other on-device power sources that can power uplink communication without using supplemental harvested RF energy (e.g., minimum transmit power of the active device<capacity of the energy storage element). The energy storage element(s) 1185 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 1100 is implemented as an ambient energy harvesting device (e.g., a passive or semi-passive energy harvesting device), a continuous carrier wave downlink signal may be received using antenna(s) 1190 and modulated (e.g., re-modulated) for uplink communication. In some cases, a modulator 1160 can be used to modulate the reflected (e.g., backscattered) portion of the downlink signal. For example, the continuous carrier wave may be a continuous sinusoidal wave (e.g., sine or cosine waveform) and modulator 1160 can perform modulation based on varying one or more of the amplitude and the phase of the backscattered reflection. Based on modulating the backscattered reflection, modulator 1160 can encode digital symbols (e.g., such as binary symbols or more complex systems of symbols) indicative of an uplink communication or data message. For example, the uplink communication may be indicative of sensor data or other information associated with the one or more sensors 1170 included in energy harvesting device 1100.

As mentioned previously, impedance matching component 1110 can be used to match the impedance of antenna(s) 1190 to the receive components of energy harvesting device 1100 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 1190. Based on varying the antenna impedance (e.g., varying the impedance mismatch between antenna(s) 1190 and the remaining components of energy harvesting device 1100), digital symbols and/or binary information can be encoded (e.g., modulated) onto the backscattered reflection. Varying the antenna impedance to modulate the phase and/or amplitude of the backscattered reflection can be performed using modulator 1160.

As illustrated in FIG. 11, a portion of a downlink signal received using antenna(s) 1190 can be provided to a demodulator 1120, which performs demodulation and provides a downlink communication (e.g., carried or modulated on the downlink signal) to a micro-controller unit (MCU) 1150 or other processor included in the energy harvesting device 1100. A remaining portion of the downlink signal received using antenna(s) 1190 can be provided to energy harvester 1130, which harvests RF energy from the downlink signal. For example, energy harvester 1130 can harvest RF energy based on performing AC-to-DC (alternating current-to-direct current) conversion, wherein an AC current is generated from the sinusoidal carrier wave of the downlink signal and the converted DC current is used to power the energy harvesting device 1100. In some aspects, energy harvester 1130 can include one or more rectifiers for performing AC-to-DC conversion. A rectifier can include one or more diodes or thin-film transistors (TFTs). In one illustrative example, energy harvester 1130 can include one or more Schottky diode-based rectifiers. In some cases, energy harvester 1130 can include one or more TFT-based rectifiers.

The output of the energy harvester 1130 is a DC current generated from (e.g., harvested from) the portion of the downlink signal provided to the energy harvester 1130. In some aspects, the DC current output of energy harvester 1130 may vary with the input provided to the energy harvester 1130. For example, an increase in the input current to energy harvester 1130 can be associated with an increase in the output DC current generated by energy harvester 1130. In some cases, MCU 1150 may be associated with a narrow band of acceptable DC current values. Regulator 1140 can be used to remove or otherwise decrease variation(s) in the DC current generated as output by energy harvester 1130. For example, regulator 1140 can remove or smooth spikes (e.g., increases) in the DC current output by energy harvester 1130 (e.g., such that the DC current provided as input to MCU 1150 by regulator 1140 remains below a first threshold). In some cases, regulator 1140 can remove or otherwise compensate for drops or decreases in the DC current output by energy harvester 1130 (e.g., such that the DC current provided as input to MCU 1150 by regulator 1140 remains above a second threshold).

In some aspects, the harvested DC current (e.g., generated by energy harvester 1130 and regulated upward or downward as needed by regulator 1140) can be used to power MCU 1150 and one or more additional components included in the energy harvesting device 1100. For example, the harvested DC current can additionally be used to power one or more (or all) of the impedance matching component 1110, demodulator 1120, regulator 1140, MCU 1150, sensors 1170, modulator 1160, etc. For example, sensors 1170 and modulator 1160 can receive at least a portion of the harvested DC current that remains after MCU 1150 (e.g., that is not consumed by MCU 1150). In some cases, the harvested DC current output by regulator 1140 can be provided to MCU 1150, modulator 1160, and sensors 1170 in series, in parallel, or a combination thereof.

In some examples, sensors 1170 can be used to obtain sensor data (e.g., such as sensor data associated with an environment in which the energy harvesting device 1100 is located). Sensors 1170 can include one or more sensors, which may be of a same or different type(s). In some aspects, one or more (or all) of the sensors 1170 can be configured to obtain sensor data based on control information included in a downlink signal received using antenna(s) 1190. For example, one or more of the sensors 1170 can be configured based on a downlink communication obtained based on demodulating a received downlink signal using demodulator 1120. In one illustrative example, sensor data can be transmitted based on using modulator 1160 to modulate (e.g., vary one or more of amplitude and/or phase of) a backscatter reflection of the continuous carrier wave received at antenna(s) 1190. Based on modulating the backscattered reflection, modulator 1160 can encode digital symbols (e.g., such as binary symbols or more complex systems of symbols) indicative of an uplink communication or data message. In some examples, modulator 1160 can generate an uplink, backscatter modulated signal based on receiving sensor data directly from sensors 1170. In some examples, modulator 1160 can generate an uplink, backscatter modulated signal based on received sensor data from MCU 1150 (e.g., based on MCU 1150 receiving sensor data directly from sensors 1170).

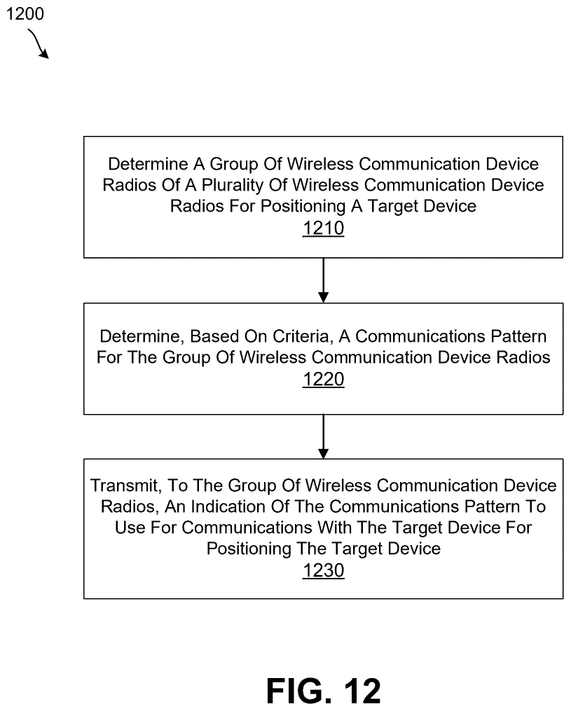

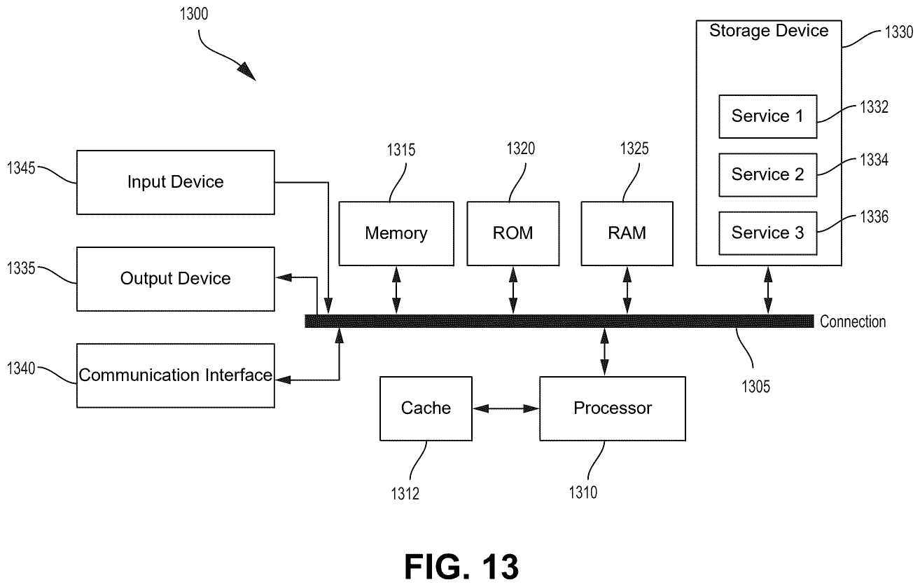

FIG. 12 is a flow chart illustrating an example of a process 1200 for wireless communications. The process 1200 can be performed by a network entity (e.g., the network entity 340 of FIG. 3, a computing device or computing system 1300 of FIG. 13, or other network entity) or by a component or system (e.g., a chipset, one or more processors central processing units (CPUs), digital signal processors (DSPs), graphics processing units (GPUs), any combination thereof, and/or other type of processor(s), or other component or system) of the network entity. The network entity can be a management entity (ME), an access point, a server (e.g., an edge server), a base station, or other type of network entity. The operations of the process 1200 may be implemented as software components that are executed and run on one or more processors (e.g., processor 1310 of FIG. 13, or other processor(s)). Further, the transmission and reception of signals by the network entity in the process 1200 may be enabled, for example, by one or more antennas and/or one or more transceivers (e.g., wireless transceiver(s)).

At block 1210, the network entity (or component thereof) can determine a group of wireless communication device radios of a plurality of wireless communication device radios (e.g., ESL radios or other types of wireless communication device radios) for positioning a target device (e.g., a mobile device such as a phone, a smart watch, a tablet, an extended reality (XR) device, etc., an ambient IOT device such as an energy harvesting electronic tag, or other device). In some aspects, the network entity (or component thereof) can determine the group of wireless communication device radios of the plurality of wireless communication device radios based on a known area including the target device (e.g., a known coarse location of the target device). In one illustrative example, as described herein, the network entity can use the known area (e.g., the known coarse location) for the target device to select a smaller group of wireless communication device radios that are located in the vicinity of the target device (e.g., located in or with a certain distance of the known coarse location of the target device) to be included in the group of wireless communication device radios.

At block 1220, the network entity (or component thereof) can determine, based on criteria, a communications pattern for the group of wireless communication device radios. In some aspects, the communications pattern is a receive pattern for the group of wireless communication device radios to receive from the target device (e.g., when the target device is an ambient IOT device). In some cases, the communications pattern is a transmit pattern for the group of wireless communication device radios to transmit to the target device (e.g., when the target device is a mobile device).

The criteria can include, for example, a confidence in a location estimate of the target device (e.g., if the target device reports a confidence metric below a confidence threshold, the network entity can change the communications pattern to improve the position accuracy), a time of day (e.g., there may be a larger number of people within an environment during certain times of the day, in which case the network entity can determine a more power-intensive communications pattern), foot traffic for an area including the target device, an accuracy requirement associated with a use case for the target device (e.g., the network entity can determine a communications pattern that can be used to provide a position estimate accuracy of at least one meter or lower for indoor navigation, a communications pattern that can be used to provide a position estimate accuracy of five meters for asset tracking of low-value objects, etc.), a buffer capacity (e.g., size requirement) for each wireless communication device radio of the plurality of wireless communication device radios (e.g., where certain communications patterns may be able to meet the buffer capacity or size requirement), presence of uplink interference, a use case associated with an identifier of the target device, any combination thereof, and/or other criteria.

At block 1230, the network entity (or component thereof) can transmit (or output for transmission), to the group of wireless communication device radios, an indication of the communications pattern to use for communications with the target device for positioning the target device.

In some aspects, the network entity (or component thereof) can group wireless communication device radios within the group of wireless communication device radios into a plurality of clusters. In some cases, the wireless communication device radios within each cluster of the plurality of clusters have a uniform spatial geometry. For example, as described herein, the network entity (or component thereof) can group the wireless communication device radios into clusters to form a uniform spatial geometry of the wireless communication device radios (e.g., such that the wireless communication device radios are uniformly spaced from one another) and to stagger the transmissions of the wireless communication device radios across time (e.g., such that different wireless communication device radios transmit at different times across time). The clusters may thus be assigned certain respective time slots for which wireless communication device radios in the cluster can transmit. In some cases, an additional duty cycle for transmissions (e.g., indicating how often transmissions will occur) may be assigned for each of the clusters. In some aspects, the communications pattern includes staggered transmissions across time for the wireless communication device radios within each cluster of the plurality of clusters. In some cases, the techniques described herein relate to a network entity, wherein the communications pattern includes staggered transmissions across time for wireless communication device radios across different clusters of the plurality of clusters.

In some cases, the computing device (e.g., the network entity) of the process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of the process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be used for wireless communication device (e.g., ESL) transmit and receive patterns for energy-efficient positioning. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A network entity for wireless communications, the network entity comprising: at least one memory; and at least one processor coupled to the at least one memory and configured to: determine a group of wireless communication device radios of a plurality of wireless communication device radios for positioning a target device; determine, based on criteria, a communications pattern for the group of wireless communication device radios; and output, for transmission to the group of wireless communication device radios, an indication of the communications pattern to use for communications with the target device for positioning the target device.

Aspect 2. The network entity of Aspect 1, wherein the at least one processor is configured to determine the group of wireless communication device radios of the plurality of wireless communication device radios based on a known area comprising the target device.

Aspect 3. The network entity of any of Aspects 1 or 2, wherein the criteria comprises at least one of confidence in a location estimate of the target device, a time of day, foot traffic for an area comprising the target device, an accuracy requirement associated with a use case for the target device, a buffer capacity for each wireless communication device radio of the plurality of wireless communication device radios, presence of uplink interference, or a use case associated with an identifier of the target device.

Aspect 4. The network entity of any of Aspects 1 to 3, wherein the target device is an ambient IOT device or a mobile device.

Aspect 5. The network entity of Aspect 4, wherein the ambient IOT device is an energy harvesting electronic tag.

Aspect 6. The network entity of any of Aspects 1 to 5, wherein the communications pattern is a receive pattern for the group of wireless communication device radios to receive from the target device.

Aspect 7. The network entity of any of Aspects 1 to 6, wherein the communications pattern is a transmit pattern for the group of wireless communication device radios to transmit to the target device.

Aspect 8. The network entity of any of Aspects 1 to 7, wherein the at least one processor is configured to group wireless communication device radios within the group of wireless communication device radios into a plurality of clusters.

Aspect 9. The network entity of Aspect 8, wherein the wireless communication device radios within each cluster of the plurality of clusters have a uniform spatial geometry.

Aspect 10. The network entity of any of Aspects 8 or 9, wherein the communications pattern comprises staggered transmissions across time for the wireless communication device radios within each cluster of the plurality of clusters.

Aspect 11. The network entity of any of Aspects 8 to 10, wherein the communications pattern comprises staggered transmissions across time for wireless communication device radios across different clusters of the plurality of clusters.

Aspect 12. The network entity of Aspect 4, wherein the mobile device is a phone, a smart watch, or a tablet.

Aspect 13. The network entity of any of Aspects 1 to 12, wherein the network entity is a management entity.

Aspect 14. The network entity of any of Aspects 1 to 13, wherein each wireless communication device radio of the plurality of wireless communication device radios is an electronic shelf label radio.

Aspect 15. A method for wireless communications at a network entity, the method comprising: determining a group of wireless communication device radios of a plurality of wireless communication device radios for positioning a target device; determining, based on criteria, a communications pattern for the group of wireless communication device radios; and transmitting, to the group of wireless communication device radios, an indication of the communications pattern to use for communications with the target device for positioning the target device.

Aspect 16. The method of Aspect 15, wherein determining the group of wireless communication device radios of the plurality of wireless communication device radios is based on a known area comprising the target device.

Aspect 17. The method of any of Aspects 15 or 16, wherein the criteria comprises at least one of confidence in a location estimate of the target device, a time of day, foot traffic for an area comprising the target device, an accuracy requirement associated with a use case for the target device, a buffer capacity for each wireless communication device radio of the plurality of wireless communication device radios, presence of uplink interference, or a use case associated with an identifier of the target device.

Aspect 18. The method of any of Aspects 15 to 17, wherein the target device is an ambient IOT device or a mobile device.

Aspect 19. The method of Aspect 18, wherein the ambient IOT device is an energy harvesting electronic tag.

Aspect 20. The method of any of Aspects 15 to 19, wherein the communications pattern is a receive pattern for the group of wireless communication device radios to receive from the target device.

Aspect 21. The method of any of Aspects 15 to 20, wherein the communications pattern is a transmit pattern for the group of wireless communication device radios to transmit to the target device.

Aspect 22. The method of any of Aspects 15 to 21, further comprising grouping wireless communication device radios within the group of wireless communication device radios into a plurality of clusters.

Aspect 23. The method of Aspect 22, wherein the wireless communication device radios within each cluster of the plurality of clusters have a uniform spatial geometry.

Aspect 24. The method of any of Aspects 22 or 23, wherein the communications pattern comprises staggered transmissions across time for the wireless communication device radios within each cluster of the plurality of clusters.

Aspect 25. The method of any of Aspects 22 to 24, wherein the communications pattern comprises staggered transmissions across time for wireless communication device radios across different clusters of the plurality of clusters.

Aspect 26. The method of Aspect 18, wherein the mobile device is a phone, a smart watch, or a tablet.

Aspect 27. The method of any of Aspects 15 to 26, wherein the network entity is a management entity.

Aspect 28. The method of any of Aspects 15 to 27, wherein each wireless communication device radio of the plurality of wireless communication device radios is an electronic shelf label radio.

Aspect 29. A non-transitory computer-readable medium having stored thereon instructions that, when executed by at least one processor, cause the at least one processor to perform operations according to any of Aspects 15 to 28.

Aspect 20. An apparatus for wireless communications, the apparatus including one or more means for performing operations according to any of Aspects 15 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A network entity for wireless communications, the network entity comprising:
at least one memory; and
at least one processor coupled to the at least one memory and configured to:
determine a group of wireless communication device radios of a plurality of wireless communication device radios for positioning a target device;
determine, based on criteria, a communications pattern for the group of wireless communication device radios; and
output, for transmission to the group of wireless communication device radios, an indication of the communications pattern to use for communications with the target device for positioning the target device.

2. The network entity of claim 1, wherein the at least one processor is configured to determine the group of wireless communication device radios of the plurality of wireless communication device radios based on a known area comprising the target device.

3. The network entity of claim 1, wherein the criteria comprises at least one of confidence in a location estimate of the target device, a time of day, foot traffic for an area comprising the target device, an accuracy requirement associated with a use case for the target device, a buffer capacity for each wireless communication device radio of the plurality of wireless communication device radios, presence of uplink interference, or a use case associated with an identifier of the target device.

4. The network entity of claim 1, wherein the target device is an ambient IOT device or a mobile device.

5. The network entity of claim 1, wherein the communications pattern is a receive pattern for the group of wireless communication device radios to receive from the target device.

6. The network entity of claim 1, wherein the communications pattern is a transmit pattern for the group of wireless communication device radios to transmit to the target device.

7. The network entity of claim 1, wherein the at least one processor is configured to group wireless communication device radios within the group of wireless communication device radios into a plurality of clusters.

8. The network entity of claim 7, wherein the wireless communication device radios within each cluster of the plurality of clusters have a uniform spatial geometry.

9. The network entity of claim 7, wherein the communications pattern comprises staggered transmissions across time for the wireless communication device radios within each cluster of the plurality of clusters.

10. The network entity of claim 7, wherein the communications pattern comprises staggered transmissions across time for wireless communication device radios across different clusters of the plurality of clusters.

11. The network entity of claim 1, wherein the network entity is a management entity.

12. The network entity of claim 1, wherein each wireless communication device radio of the plurality of wireless communication device radios is an electronic shelf label radio.

13. A method for wireless communications at a network entity, the method comprising:
determining a group of wireless communication device radios of a plurality of wireless communication device radios for positioning a target device;
determining, based on criteria, a communications pattern for the group of wireless communication device radios; and
transmitting, to the group of wireless communication device radios, an indication of the communications pattern to use for communications with the target device for positioning the target device.

14. The method of claim 13, wherein determining the group of wireless communication device radios of the plurality of wireless communication device radios is based on a known area comprising the target device.

15. The method of claim 13, wherein the criteria comprises at least one of confidence in a location estimate of the target device, a time of day, foot traffic for an area comprising the target device, an accuracy requirement associated with a use case for the target device, a buffer capacity for each wireless communication device radio of the plurality of wireless communication device radios, presence of uplink interference, or a use case associated with an identifier of the target device.

16. The method of claim 13, wherein the target device is an ambient IOT device or a mobile device.

17. The method of claim 16, wherein the ambient IOT device is an energy harvesting electronic tag.

18. The method of claim 13, wherein the communications pattern is a receive pattern for the group of wireless communication device radios to receive from the target device.

19. The method of claim 13, wherein the communications pattern is a transmit pattern for the group of wireless communication device radios to transmit to the target device.

20. The network entity of claim 13, further comprising grouping wireless communication device radios within the group of wireless communication device radios into a plurality of clusters.
